(19) United States
(12) Patent Application Publication
(10) Pub. No.: US 2016/0028229 A1
(43) Pub. Date: Jan. 28, 2016

(54) POWER SUPPLY SYSTEM

(71) Applicant: TOYOTA JIDOSHA KABUSHIKI KAISHA, Toyota-shi Aichi-ken (JP)

(72) Inventor: Noritake Mitsutani, Toyota-shi Aichi-ken (JP)

(21) Appl. No.: 14/803,492

(22) Filed: Jul. 20, 2015

(30) Foreign Application Priority Data
Jul. 22, 2014 (JP) 2014-148894

(51) Int. Cl. H02J 1/00

(52) U.S. Cl. CPC H02J 1/00

(57) ABSTRACT

A power supply system includes: a load; a power line connected to the load; first and second DC power supplies being capable of supplying electric power to the load; a power converter connected between the first and second DC power supplies and the power line; and a controller for controlling an operation of the power converter. When shifting of the first operating mode employing only one of the first and second power supplies to the second operating mode employing both the first and second power supplies is started, the controller sets input and output power command values for other of the first and second DC power supplies to be equal to or higher than a lower limit value, and maintains, within a predetermined range, a ratio of the input and output power command values for the first and second DC power supplies, relative to the power demanded by the load.

### PRIORITY INFORMATION

This application claims priority to Japanese Patent Application No. 2014-148894 filed on Jul. 22, 2014, which is incorporated herein by reference in its entirety.

### TECHNICAL FIELD

The present invention relates to a power supply system that includes a power converter connected between a plurality of DC power supplies, and power lines used in common.

### BACKGROUND ART

A vehicle electric power supply system where two DC power supplies are connected in parallel to power lines via converters has been disclosed in JP 2011-97693 A (hereinafter referred to as patent document 1). In the description, the power supply system performs voltage control for one of the DC power supplies, while performing power control for the other DC power supply through feedback control, so that the two DC power supplies cooperate together to supply electric power demanded by a motor that serves as a load. Further, based on a deviation of an actual power value that is actually input/output, relative to a power command value requested for the DC power supply, for which power control is performed, the power supply system modifies a target power value that is to be set for this DC power supply in accordance with a power distribution ratio. Therefore, according to the description, adverse effects, such as over-discharge and overcharge, due to the deviation of the actual power value from the power command value can be eliminated, and stable power management can be performed.

For the vehicle electric power supply system in patent document 1, the power distribution ratio is determined based on conditions, such as SOC and a temperature, of the individual power supplies, and a load request, in order to appropriately employ the individual DC power supplies.

In the power supply system, a burden of power imposed on one of the DC power supplies may be higher than the burden imposed on the other DC power supply, with respect to the target power value provided based on the power distribution ratio. For example, when the power distribution ratio for a first DC power supply is increased, a ratio of boosting by a power converter; i.e., a system voltage, is raised to satisfy power demanded by a load. Then, a difference between the system voltage and the voltage of a second DC power supply may be increased, and overcharge of the second DC power may occur. In contrast, when the power distribution ratio of the first DC power supply is reduced, power taken from the second DC power supply may be increased, and over-discharge of the second power supply may occur. Therefore, in a case wherein the electric power is supplied by the first and second DC power supplies to satisfy the power demanded by the load, the power distribution ratio should be set to appropriately adjust the power that is input and output by the individual DC power supplies.

### SUMMARY OF THE INVENTION

One objective of the present invention is to provide a power supply system that can perform appropriate power distribution for first and second DC power supplies to prevent the occurrence of overpower, such as over-discharge or overcharge, in either of the DC power supplies.

A power supply system according to the present invention including:

a load;

a power line connected to the load;

first and second DC power supplies being capable of supplying electric power to the load;

a power converter connected between the first and second DC power supplies and the power line; and

a controller for controlling an operation of the power converter,

wherein the first and second DC power supplies are capable of being connected in parallel to the power line,

wherein an operating mode is capable of being switched between a first operating mode, in which only one of the first and second DC power supplies inputs or outputs electric power demanded by the load, and a second operating mode, in which the electric power demanded by the load is distributed into power to be input/output respectively by the first and second DC power supplies, and the first and second DC power supplies input and output the power thus distributed, and

wherein when shifting of the first operating mode to the second operating mode is started, the controller sets input and output power command values for other of the first and second DC power supplies to be equal to or higher than a lower limit value, and maintains, within a predetermined range, a ratio of the input and output power command values for the first and second DC power supply, relative to the power demanded by the load.

According to the power supply system of this invention, the controller may be capable of performing feedback control to bring actual power values of the first and second DC power supplies close to the input and output power command values, and, when the actual power of the other of the first and second DC power supplies is lower than a predetermined power threshold value in the second operating mode, the controller may inhibit the feedback control for increasing the actual power of the one of the first and second DC power supplies.

In this case, when the actual power of the other of the first and the second power supplies is lower than the predetermined power threshold value, the controller may inhibit the feedback control for increasing the actual power of the one of the first and second DC power supplies, and when the actual power of the other of the first and second power supplies is equal to or higher than the predetermined power threshold value, the controller may allow the feedback control for increasing the actual power of the one of the first and second DC power supplies.

According to the power supply system of this invention, in a case wherein power distribution is performed for the first and second DC power supplies to satisfy the power demanded by the load, the occurrence of overpower in either the first or second DC power supply can be prevented.

### BRIEF DESCRIPTION OF THE DRAWINGS

FIG. 1 is a diagram showing the configuration of a power supply system according to one embodiment of the present invention;

FIG. 2 is a schematic diagram illustrating an example arrangement of a load shown in FIG. 1;

FIG. 3 is a table for explaining a plurality of different operating modes for a 15 power converter in FIG. 1;

FIG. 4A is a circuit diagram for explaining DC/DC conversion (boosting) for a first DC power supply in a PB mode in which the ON state of the lower arm elements of the boost chopper is obtained;

FIG. 4B is a circuit diagram for explaining DC/DC conversion (boosting) for a first DC power supply in a PB mode in which the ON state of the upper arm elements of the boost chopper is obtained;

FIG. 5A is a circuit diagram for explaining DC/DC conversion (boosting) for a second DC power supply in the PB mode in which the ON state of the lower arm elements of the boost chopper is obtained;

FIG. 5B is a circuit diagram for explaining DC/DC conversion (boosting) for a second DC power supply in the PB mode in which the ON state of the upper arm elements of the boost chopper is obtained;

FIG. 6 is a waveform diagram showing an example for controlling the switching elements of the power converter in the PB mode;

FIG. 7 is a table for explaining logical expression to set control signals for the individual switching elements in the PB mode;

FIG. 8A is a circuit diagram for explaining DC/DC conversion 25 (boosting) in an SB mode in which the ON state of the lower arm elements of the step-up chopper circuits is provided;

FIG. 8B is a circuit diagram for explaining DC/DC conversion 25 (boosting) in an SB mode in which the ON state of the upper arm elements of the step-up chopper circuits is provided;

FIG. 9 is a waveform diagram showing an example for controlling the individual switching elements in the SB mode;

FIG. 10 is a table for explaining logical expression to set the operation for controlling the individual switching elements in the SB mode;

FIG. 11A is a circuit diagram for explaining DC/DC conversion for the first DC power supply and direct connection of the second DC power supply in a PBD mode in which the ON state of the lower arm element of the step-up chopper is established;

FIG. 11B is a circuit diagram for explaining DC/DC conversion for the first DC power supply and direct connection of the second DC power supply in a PBD mode in which the ON state of the upper arm element of the step-up chopper is established;

FIG. 12 is a waveform diagram showing an example control operation for the individual switching elements in the PBD mode;

FIG. 13 is a table for explaining logical expressions to set the control operation of the individual switching elements in the PBD mode;

FIG. 14 is a table, employed for the individual operating modes in FIG. 3, to represent whether the control of a power distribution ratio for the DC power supplies is enabled or disabled, and to compare ranges available for setting an output voltage;

FIG. 15 is a conceptual diagram for explaining the definition of a voltage range for a voltage demanded by a load;

FIG. 16 is a table for explaining a selection of an operating mode for each voltage 15 range shown in FIG. 15;

FIG. 17 is a conceptual diagram for explaining the basic concept of controlling the power converter in this embodiment;

FIG. 18 is a block diagram for explaining the control of the power converter in this embodiment;

FIG. 19 is another block diagram for explaining the control of the power converter in this embodiment;

FIG. 20 is a graph showing a relationship between a duty ratio and a power distribution ratio for the first DC power supply in the PB mode;

FIG. 21 is a functional block diagram for an overpower avoidance control unit of 25 a controller;

FIG. 22 is a flowchart showing the overpower avoidance control processing performed by the controller;

FIG. 23A is a graph provided when the overpower avoidance control is performed; showing changes of a power command value and actual power for the first DC power supply;

FIG. 23B is a graph provided when the overpower avoidance control is performed showing a change of a boost ratio for the first DC power supply;

FIG. 23C is a graph provided when the overpower avoidance control is performed showing changes of the power command value and the actual value for a second DC power supply; and

FIG. 24 is a diagram showing another example configuration of the power supply system.

### DESCRIPTION OF THE EMBODIMENT

One embodiment of the present invention will now be described in detail while referring to the accompanying drawings. In the explanation, shapes, materials, numerical values, and directions specifically provided are merely examples to make the present invention easily understood, and can be changed, as needed, in accordance with applications, purposes, and specifications. Further, in a case wherein a plurality of embodiments and modifications are included in the following description, it is originally assumed that the features of these embodiments or modifications are combined properly for use.

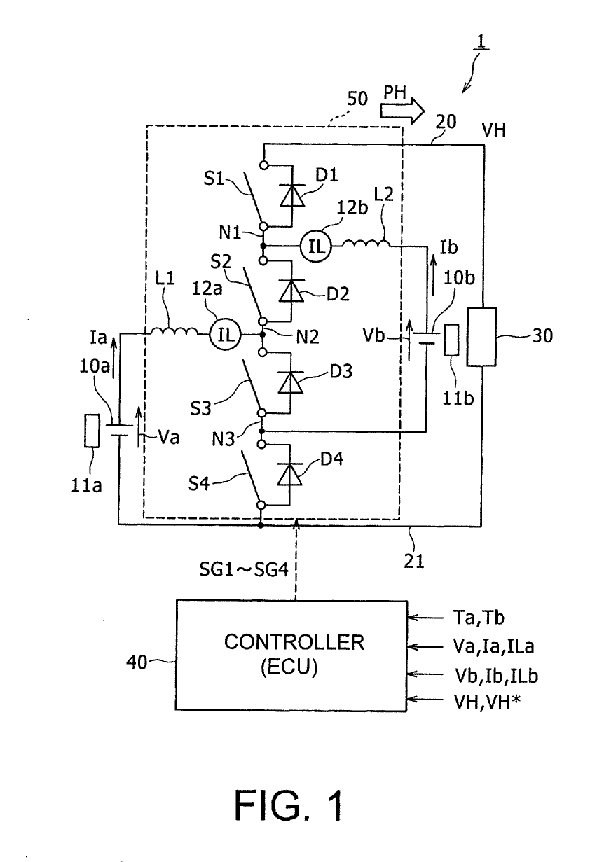

FIG. 1 is a circuit diagram showing the configuration of a power supply system according to the embodiment of the present invention. A power supply system 1 includes a first DC power supply 10a and a second DC power supply 10b, a load 30, a controller 40, and a power converter 50.

In this embodiment, the first and second DC power supplies 10a and 10b are provided by employing a secondary battery, such as a lithium-ion battery or a nickel-hydrogen battery, or a DC voltage source component, such as an electric double layer capacitor or a lithium-ion capacitor, that has a superior output characteristic. The first and second DC power supplies 10a and 10b may be provided as DC power supplies of the same type having the same capacitance, or as DC power supplies of different types having different capacitances.

The power converter 50 is connected between the first and second DC power supplies 10a and 10b and a power line 20. The power converter 50 controls, based on a voltage command value VH*, a DC voltage (hereinafter referred to also as a system voltage VH) on the power line 20 that is connected to the load 30. That is, the power line 20 is employed in common for the first and second DC power supplies 10a and 10b.

The load 30 is operated upon receiving the system voltage VH that is a voltage output by the power converter 50. The voltage command value VH* is variably set as a voltage suitable for the operation of the load 30, in accordance with the operating state, such as a torque or a rotation speed, of the load 30. The load 30 may be configured, so that electric energy for charging the first and second DC power supplies 10a and 10b can be generated by power regeneration.

The power converter 50 includes switching elements S1 to S4 and reactors L1 and L2. In this embodiment, IGBTs (Insulated Gate Bipolar Transistors), for example, can be employed as the switching elements S1 to S4. Anti-parallel diodes D1 to D4 are connected to the switching elements S1 to S4.

The ON/OFF states of the switching elements S1 to S4 can be controlled in response to control signals SG1 to SG4, respectively. That is, the switching elements S1 to S4 are turned on when the control signals SG1 to SG4 are active-high (hereinafter referred to as level H), or turned off when the signals SG1 to SG4 are active-low (hereinafter, referred to as level L).

The switching element S1 is electrically connected between the power line 20 and a node N1. The reactor L2 is connected between the node N1 and the positive terminal of the second DC power supply 10b. A current ILb that flows across the reactor L2 is detected by a current sensor 12b, and is transmitted to the controller 40. The switching element S2 is electrically connected between the node N1 and a node N2. The reactor L1 is connected between the node N2 and the positive terminal of the first DC power supply 10a. A current ILa that flows across the reactor L1 is detected by a current sensor 12a, and is transmitted to the controller 40.

The switching element S3 is electrically connected between the node N2 and a node N3. The node N3 is electrically connected to the negative terminal of the second DC power supply 10b. The switching element S4 is electrically connected between the node N3 and a ground line 21. The ground line 21 is electrically connected between the load 30 and the negative terminal of the first DC power supply 10a.

As apparent from FIG. 1, the power converter 50 includes step-up choppers, respectively for the first DC power supply 10a and the second DC power supply 10b. That is, for the first DC power supply 10a, a first DC bidirectional step-up chopper is provided, wherein the switching elements S1 and S2 are employed as upper arm elements, and the switching elements S3 and S4 are employed as lower arm elements. Likewise, for the second DC power supply 10b, a second DC bidirectional step-up chopper is provided, wherein the switching elements S1 and S4 are employed as upper arm elements, and the switching elements S2 and S3 are employed as lower arm elements.

Because of the first step-up chopper, the switching elements S1 to S4 are present along both a power conversion path extended between the first DC power supply 10a and the power line 20 and a power conversion path extended between the second DC power supply 10b and the power line 20.

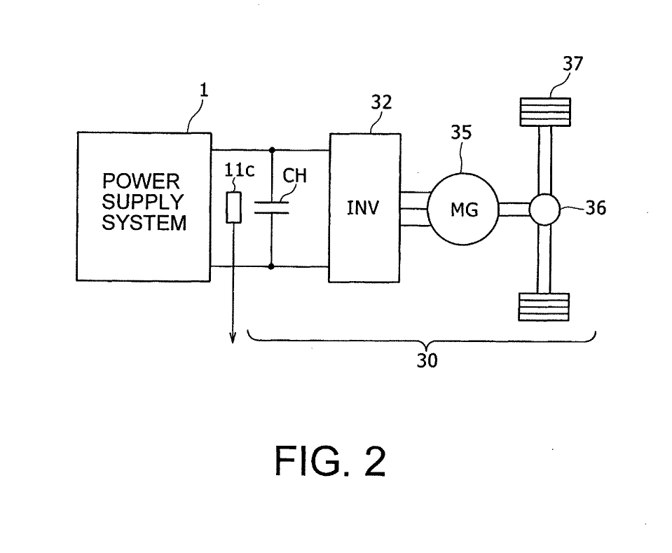

The controller 40 generates the control signals SG1 to SG4 for controlling the ON/OFF states of the switching elements S1 to S4 in order to control the system voltage VH applied to the load 30. The controller 40 receives a voltage Va of the first DC power supply 10a that is detected by a voltage sensor 11a, a current Ia that flows across the first DC power supply 10a and is detected by a current sensor (not shown), a voltage Vb of the second DC power supply 10b that is detected by a voltage sensor 11b, and a current Ib of the second DC power supply 10b that is detected by a current sensor (also not shown). The controller 40 also receives temperatures Ta and Tb of the first and second DC power supplies 10a and 10b that are detected by temperature sensors (not shown). Further, the controller 40 also receives the system voltage VH of the power converter 50 that is detected by a voltage sensor 11c (see FIG. 2).

In a case wherein a power distribution line extended to auxiliary equipment is not connected between the first DC power supply 10a and the reactor L1, the current ILa that flows across the reactor L1 can be regarded as equal to the current Ia of the first DC power supply 10a. Likewise, in a case wherein a power distribution line extended to auxiliary equipment is not connected between the second DC power supply 10b and the reactor L2, the current ILb that flows across the reactor L2 can be regarded as equal to the current Ib of the second DC power supply 10b.

FIG. 2 is a schematic diagram showing an example arrangement for the load 30. The load 30 is provided to include, for example, an electric motor for propulsion of an electric vehicle. The load 30 includes a smoothing capacitor CH, an inverter 32, a motor generator 35, a power transmission gear 36 and driving wheels 37.

The motor generator 35 is a traction motor that generates the drive force of a vehicle, and is provided as, for example, a multi-phase permanent-magnet synchronous motor. The output torque of the motor generator 35 is transmitted to the driving wheels 37 via the power transmission gear 36 that includes a speed reducer and a power split mechanism. An electric vehicle is propelled by a torque that is transmitted to the driving wheels 37 via the power transmission gear 36. Further, at the time of regenerative braking of the electric vehicle, the motor generator 35 generates power by the rotation force of the driving wheels 37. The generated power is converted from AC power to DC power by the inverter 32, and the DC power can be employed as power for charging the first and second DC power supplies 10a and 10b that are included in the power supply system 1.

For a hybrid car wherein an engine (not shown) is mounted in addition to a motor generator, the engine and the motor generator 35 cooperate together to generate a vehicle driving force required for the electric vehicle. At this time, electric power generated by the rotation of the engine may also be employed to charge the first and second DC power supplies 10a and 10b.

As described above, an electric vehicle comprehensively represents a vehicle where a traction motor is mounted, and includes a hybrid car that generates a propulsion force for a vehicle by an engine and an electric motor, and an electric car and a fuel-cell car where an engine is not mounted. A plurality of motor generators employed as a drive force source or a power generator may also be mounted to an electric vehicle.

### (Operating Modes of Power Converter)

The power converter 50 has a plurality of operating modes having different forms of DC power conversion performed between the first and second DC power supplies 10a, 10b and the power line 20.

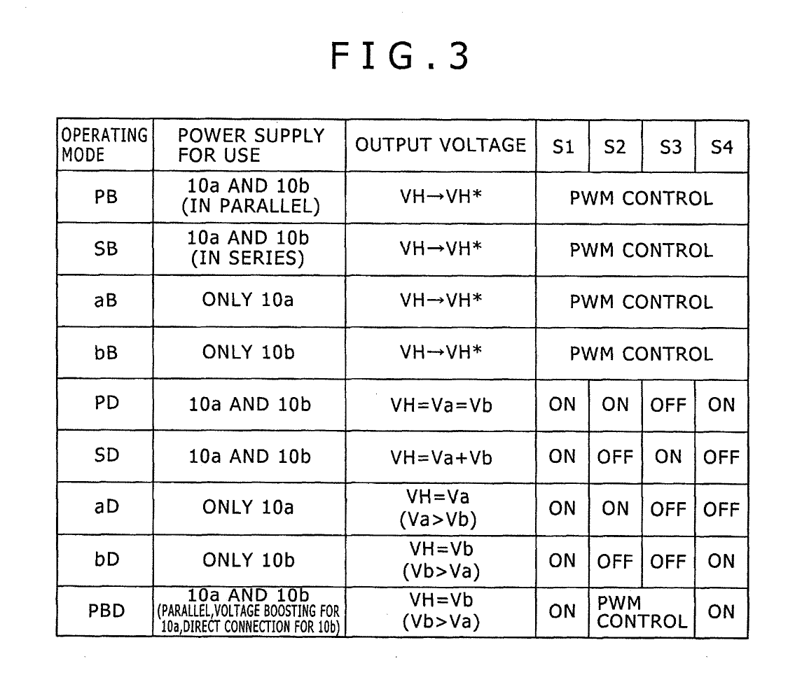

A plurality of operating modes of the power converter 50 are shown in FIG. 3. As shown in FIG. 3, the operating modes are roughly classified into a “boost mode (B),” in which boosting of the voltage output by the first DC power supply 10a and/or the second DC power supply 10b is performed in association with periodic ON/OFF of the switching elements S1 to S4, and a “direct connection mode (D),” in which the first DC power supply 10a and/or the second DC power supply 10b are electrically and directly connected to the power line 20, while the ON/OFF states of the switching elements S1 to S4 are fixed.

The boost mode includes a “parallel boost mode (hereinafter referred to as a PB mode),” in which parallel DC/DC conversion is performed between the DC power supplies 10a, 10b and the power line 20, a “series boost mode (hereinafter, referred to as an SB mode),” in which DC/DC conversion is performed between the DC power supplies 10a and 10b connected in series and the power line 20, and a “parallel boost direct connection mode (hereinafter, referred to as a PBD mode),” in which DC/DC conversion is performed for one of the DC power supplies 10a and 10b and the power line 20, and the remaining DC power supply 10a or 10b is directly connected to the power line 20 in parallel to the DC power supply 10a or 10b employed for DC/DC conversion. Since the PBD mode is an operating mode accompanied by the boosting operation for one of the DC power supplies, in the following description, the PBD mode is regarded as a mode classified into the “boost mode (B).”

The boost mode also includes an “independent mode using the first DC power supply 10a (hereinafter referred to as an aB mode),” in which only the first DC power supply 10a is employed to perform DC/DC conversion for this DC power supply and the power line 20, and an “independent mode using the second DC power supply 10b,” (hereinafter referred to as a bBmode) in which only the second DC power supply 10b is employed to perform DC/DC conversion for this DC power supply and the power line 20. In the aB mode, so long as the system VH is adjusted higher than the voltage of the second DC power supply 10b, the second DC power supply 10b is unused, while the state in which the second DC power supply 10b is electrically separated from the power line 20 is maintained. Likewise, in the bB mode, so long as the system VH is adjusted higher than the voltage of the first DC power supply 10a, the first DC power supply 10a is unused, while the state in which the first DC power supply 10a is electrically separated from the power line 20 is maintained.

In the PB mode, the SB mode, the aB mode, and the bB mode included in the boost mode, the system voltage VH of the power line 20 is controlled based on the voltage command value VH*. In contrast, in the PBD mode, since the second DC power supply 10b is directly connected to the power line 20, the output voltage VH on the power line 20 is equal to the voltage Vb of the DC power supply 10b. The control for the switching elements S1 to S4 in the individual modes will be described later.

The direct connection mode includes a “parallel direct-connection mode (hereinafter referred to as a PD mode),” in which the state wherein the first and second DC power supplies 10a and 10b are connected in parallel to the power line 20 is maintained, and a “series direct-connection mode (hereinafter referred to an SD mode),” in which the state wherein the first and second DC power supplies 10a and 10b are connected in series to the power line 20 is maintained.

In the PD mode, the switching elements S1, S2, and S4 are fixed to the ON state, and the switching element S3 is fixed to the OFF state. As a result, the system voltage VH is equal to the voltage Va or Vb (strictly speaking, a higher voltage of the two voltages Va and Vb) output by the first or second DC power supply 10a or 10b. Since a voltage difference of the voltages Va and Vb causes a short-circuit current between the DC power supplies 10a and 10b, the PD mode can be employed so long as a voltage difference is small.

In the SD mode, the switching elements S2 and S4 are held in the OFF state, and the switching elements S1 and S3 are held in the ON state. As a result, the system voltage VH is equal to the sum of the voltages Va and Vb output by the first and second DC power supplies 10a and 10b (VH=Va+Vb).

The direct connection mode also includes a “mode for direct connection of the first DC power supply 10a (hereinafter referred to as an aD mode),” in which only the DC power supply 10a is electrically connected to the power line 20, and a “mode for direct connection of the second DC power supply 10b (hereinafter referred to as a bD mode),” in which only the second DC power supply 10b is electrically connected to the power line 20.

In the aD mode, the switching elements S1 and S2 are held in the ON state, while the switching elements S3 and S4 are held in the OFF state. As a result, the state wherein the second Dc power supply 10b is electrically separated from the power line 20 is established, and the system voltage VH is set equal to the voltage Va of the first DC power supply 10a (VH=Va). In the aD mode, the second DC power supply 10b is unused, while the state wherein the second DC power supply 10b is electrically separated from the power line 20 is maintained. When the aD mode is employed in the state of Vb>Va, a short-circuit current flows from the second DC power supply 10b to the first DC power supply 10a via the switching element S2. Therefore, Va>Vb is a requirement for use of the aD mode.

Likewise, in the bD mode, the switching elements S1 and S4 are held in the ON state, while the switching elements S2 and S3 are held in the OFF state. As a result, the state wherein the first DC power supply 10a is electrically separated from the power line 20 is established, and the system voltage VH is set equal to the voltage Vb of the second DC power supply 10b (VH=Vb). In the bD mode, the first DC power supply 10a is unused, while the state wherein the first DC power supply 10a is electrically separated from the power line 20 is maintained. When the bD mode is employed in the state of Va>Vb, a short-circuit current flows from the first DC power supply 10a to the second DC power supply 10b via the diode D2. Therefore, Vb>Va is a requirement for use of the bD mode.

In the PD mode, the SD mode, the aD mode, and the bD mode included in the direct connection mode, since the system voltage VH of the power line 20 is determined in accordance with the voltages Va and Vb of the DC power supplies 10a and 10b, the system voltage VH cannot be directly controlled. Therefore, in the individual modes included in the direct connection mode, the system voltage VH cannot be set at a voltage level appropriate for the operation of the load 30, and therefore, there is a possibility that the power loss at the load 30 will be increased.

On the other hand, since turning on or off of the switching elements S1 to S4 is not performed in the direct connection mode, the power loss at the power converter 50 is considerably reduced. Therefore, depending on the operating state of the load 30, there is a possibility that when the direct connection mode is employed, the reduction in the power loss of the power converter 50 may be greater than the increase in the power loss of the load 30, and the total power loss for the power supply system 1 can be suppressed.

The same is applied for the PBD mode, which is a unique operating mode for this embodiment. Specifically, in the PBD mode, since one of the DC power supplies, 10a or 10b, is connected in parallel to the other DC power supply 10b or 10a, and directly to the power line 20, the system voltage VH is equal to the voltage Va or Vb of the DC power supply 10a or 10b, and therefore, direct control of the system voltage VH cannot be performed. However, since turning on or off of the two of the switching elements S1 to S4 associated with the DC power supply directly connected is not performed, power loss of the power converter 50 is greatly reduced, and depending on the operating state of the load 30, there is a possibility that the total power loss of the power supply system 1 can be suppressed by using the PBD mode.

It is preferable for the power supply system of this embodiment that the first DC power supply 10a is provided by using a high-output-type power supply, and the second DC power supply 10b is provided by using a high-capacity-type power supply. With this arrangement, in a case wherein a user has manipulated the accelerator of an electric vehicle to issue a request for rapid acceleration, this request is coped with by the output of the high-output type DC power supply 10a, and in a case wherein a request for comparatively low power of an electric vehicle, such as continuous high-speed steady running, has been issued for a long period of time, this request can be coped with by the output of the high-capacity type DC power supply 10b. When energy accumulated in the high-capacity DC power supply 10b is employed for an extended period of time, the mileage of the electric vehicle using electric energy can be increased, and the acceleration performance in consonance with the user's manipulation of the accelerator can be promptly obtained.

However, in a case wherein the DC power supply is provided by employing a battery, there is a possibility that the output characteristics might be degraded at a low temperature, or charging/discharging might be limited in order to suppress a deterioration at a high temperature. Therefore, the power supply system 1 performs the processing for limiting output power PH of the power line 20 that corresponds to the electric power demanded by the load 30, so that the occurrence of excessive charging/discharging beyond a limit value is prevented under the condition that the charging/discharging of the individual DC power supplies 10a and 10b is limited.

### (Voltage Step-up Operation in the PB Operating Mode)

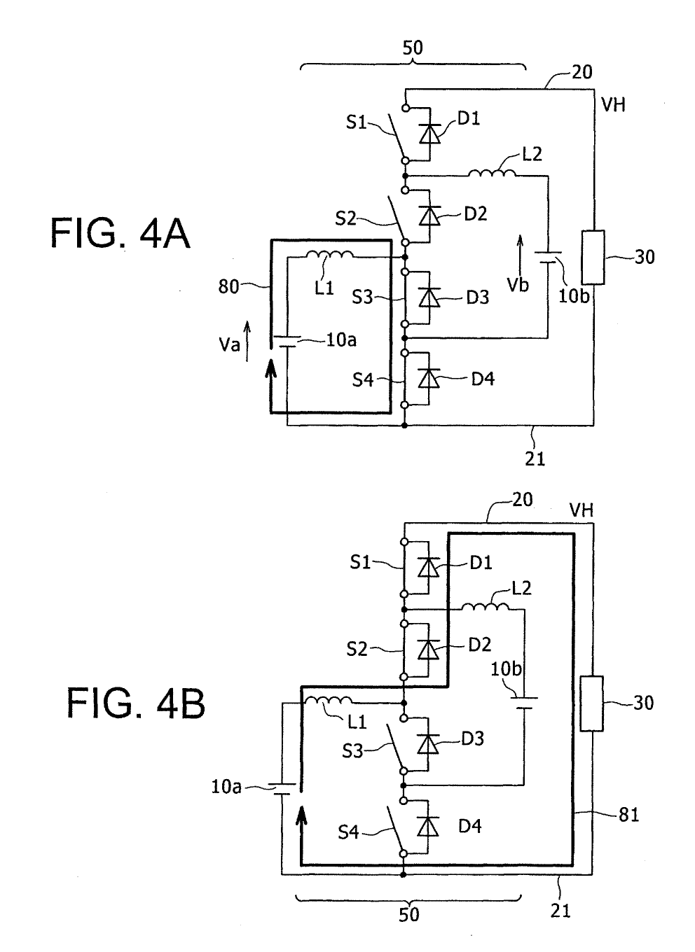

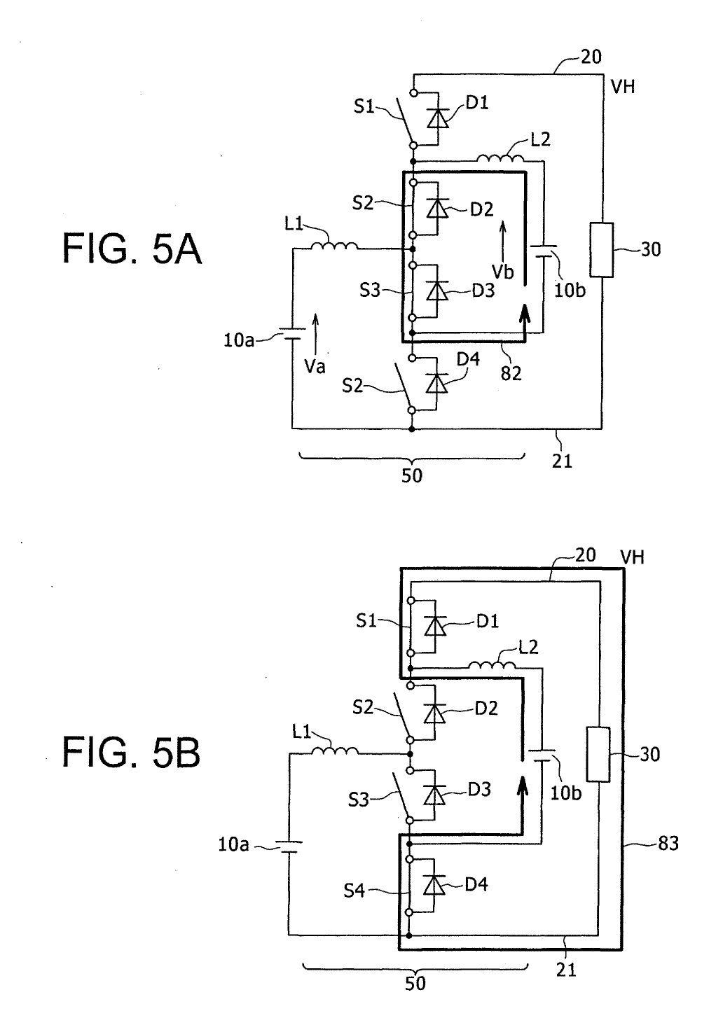

The voltage step-up operation in the PB operating mode will now be described in detail, while referring to FIGS. 4A and 4B and FIGS. 5A and 5B. In FIGS. 4A and 4B, DC/DC conversion (voltage step-up operation) for the first DC power supply 10a in the PB mode is shown. As shown in FIG. 4A, a current path 80 used to accumulate energy in the reactor L1 is formed by turning on the pair of the switching elements S3 and S4, and turning off the pair of the switching elements S1 and S2. As a result, the ON state of the lower arm elements of the boost chopper is obtained.

In contrast, as shown in FIG. 4B, a current path 81 used to output the energy accumulated in the reactor L1, together with the energy of the first DC power supply 10a, is formed by turning off the pair of the switching elements S3 and S4, and turning on the pair of the switching elements S1 and S2. As a result, the ON state of the upper arm elements of the boost chopper is obtained. At this time, since a current flows across the diodes D1 and D2 along the current path 81, the switching elements S1 and S2 serve as switches that form a current path, along which the regenerative power of the load 30 is supplied to charge the DC power supply 10a.

A step-up chopper circuit for the first DC power supply 10a is obtained by alternatively repeating a first period, during which the two switching elements S3 and S4 are ON as described above, while at least one of the switching elements S1 and S2 is OFF, and a second period during which the two switching elements S1 and S2 are ON, and at least one of the switching elements S3 and S4 is OFF. In this case, since a current path extended to the second DC power supply 10b is not formed in the DC/DC conversion operation shown in FIGS. 4A and 4B, the DC power supplies 10a and 10b are non-interactive. That is, input/output of power with respect to the DC power supplies 10a and 10b can be independently controlled.

For the DC/DC conversion, a relationship represented by expression (1) below is established for the voltage Va of the first DC power supply 10a and the system voltage VH of the power line 20. In expression (1), a duty ratio in a period where the two switching elements S3 and S4 are ON is denoted by Da.

VH=1/(1−Da)·Va (1)

In FIGS. 5A and 5B, DC/DC conversion (step-up operation) for the second DC power supply 10b in the PB mode is shown. As shown in FIG. 5A, a current path 82 used to accumulate energy in the reactor L2 is formed by turning on the two switching elements S2 and S3, and turning off the two switching elements S1 and S4. As a result, the ON state of the lower arm elements of the boost chopper is obtained.

In contrast, as shown in FIG. 5B, a current path 83 used to output the energy accumulated in the reactor L2, together with the energy of the second DC power supply 10b, is formed by turning off the two switching elements S2 and S3, and turning on the two switching elements S1 and S4. As a result, the ON state of the upper arm elements of the boost chopper is obtained. At this time, since a current flows across the diode D1 along the current path 83, the switching element S1 serves as a switch that forms a current path, along which the regenerative power of the load 30 is supplied to charge the DC power supply 10b.

A step-up chopper circuit for the second DC power supply 10b is obtained by alternatively repeating a first period, during which the two switching elements S2 and S3 are ON as described above, while at least one of the switching elements S1 and S4 is OFF, and a second period during which the two switching elements S1 and S4 are ON, and at least one of the switching elements S2 and S3 is OFF. In this case, since a current path extended to the first DC power supply 10a is not formed in the DC/DC conversion operation shown in FIGS. 5A and 5B, the DC power supplies 10a and 10b are non-interactive. That is, input/output of power with respect to the DC power supplies 10a and 10b can be independently controlled.

For the DC/DC conversion, a relationship represented by expression (2) below is established for the voltage Vb of the second DC power supply 10b and the system voltage VH of the power line 20. In expression (2), a duty ratio in a period where the two switching elements S2 and S3 are ON is denoted by Db.

VH=1/(1−Db)·Vb (2)

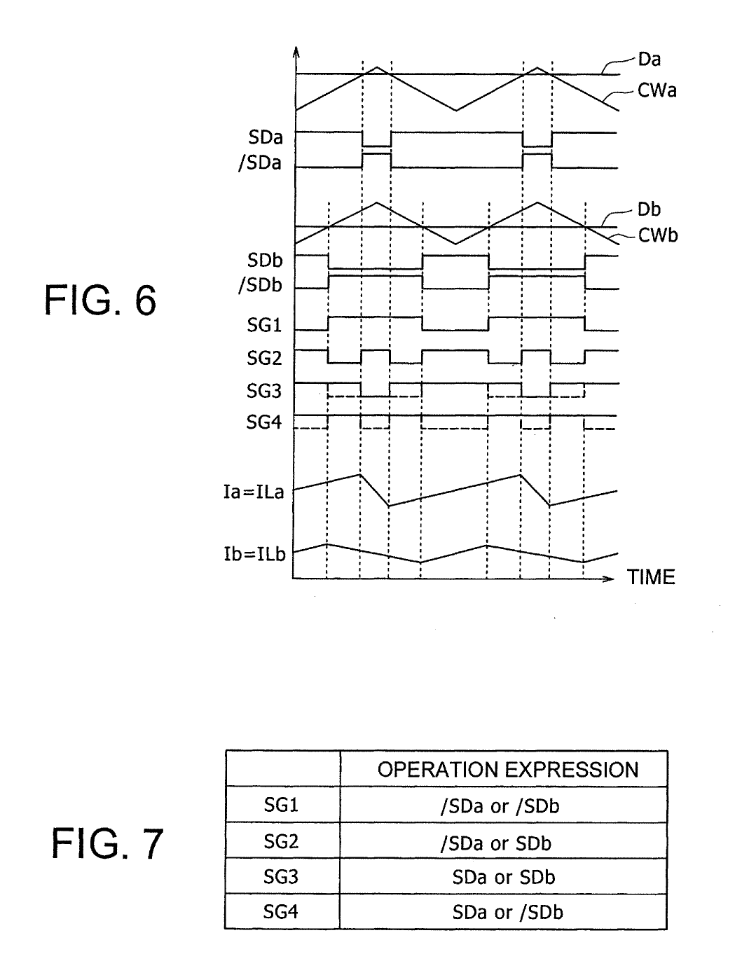

FIG. 6 is a waveform diagram for explaining an example operation for controlling the switching elements in the PB mode. The example in FIG. 6 represents the operation performed when the same frequency and the same phase are provided for a carrier wave CWa, used for PWM (Pulse Width Modulation) control of the first DC power supply 10a, and a carrier wave CWb, used for PWM control of the second DC power supply 10b.

While referring to FIG. 6, in the PB mode, for example, the output of one of the DC power supplies 10a and 10b can be controlled (voltage control) to compensate for a voltage deviation ΔVH (ΔVH=VH*−VH) of the system voltage VH, while the output of the other DC power supply 10a or 10b can be controlled (current control) to compensate for a current deviation of currents Ia and Ib. At this time, a command value (Ia* or Ib*) for current control can be set to control the output power of the pertinent DC power supply.

As an example, when voltage control is performed for the output of the second DC power supply 10b, and current control is performed for the output of the first DC power supply 10a, the duty ratio Da is calculated based on the current deviation ΔIa (ΔIa=Ia*−Ia), while the duty ratio Db is calculated based on the voltage deviation ΔVH.

A control pulse signal SDa is generated based on voltage comparison between the duty ratio Da, used to control the output of the first DC power supply 10a, and the carrier wave CWa. Also, a control pulse signal SDb is generated based on a comparison between the duty ratio Db, used to control the output of the second DC power supply 10b, and the carrier wave CWb. Control pulse signals /SDa and /SDb are inversion signals of the control pulse signals SDa and SDb.

As shown in FIG. 7, the control signals SG1 to SG4 are set based on the logical operation of the control pulse signals SDa (/SDa) and SDb (/SDb). Specifically, the switching element S1 serves as the upper arm element for the individual step-up chopper circuits in FIGS. 4A and 4B and FIGS. 5A and 5B. Therefore, the control signal SG1 for controlling the ON/OFF state of the switching element S1 is generated based on the logical sum of the control pulse signals /SDa and /SDb.

The switching element S2 serves as the upper arm element for the step-up chopper circuit in FIGS. 4A and 4B, or serves as the lower arm element for the step-up chopper circuit in FIGS. 5A and 5B. Therefore, the control signal SG2 for controlling the ON/OFF state of the switching element S2 is generated based on the logical sum of the control pulse signals /SDa and SDb.

The switching element S3 serves as the lower arm element for the individual step-up chopper circuits in FIGS. 4A and 4B and FIGS. 5A and 5B. Therefore, the control signal SG3 for controlling the ON/OFF state of the switching element S3 is generated based on the logical sum of the control pulse signals SDa and SDb.

The switching element S4 serves as the lower arm element for the step-up chopper circuit in FIGS. 4A and 4B, or serves as the upper arm element for the step-up chopper circuit in FIGS. 5A and 5B. Therefore, the control signal SG4 for controlling the ON/OFF state of the switching element S4 is generated based on the logical sum of the control pulse signals SDa and /SDb.

As apparent from FIGS. 6 and 7, since the control signals SG2 and SG4 are set at complementary levels in the PB mode, the switching elements S2 and S4 are complementarily turned on or off. Further, since the control signals SG1 and SG3 are set at complementary levels, the switching elements S1 and S3 are turned on or off complementarily. As a result, DC conversion for the DC power supplies 10a and 10b can be performed based on the duty ratios Da and Db.

Referring again to FIG. 6, a current ILa that flows across the reactor L1 and a current ILb that flows across the reactor L2 are controlled by turning on or off the switching elements S1 to S4 in accordance with the control signals SG1 to SG4. In this embodiment, the current ILa corresponds to the current Ia of the first DC power supply 10a, while the current ILb corresponds to the current Ib of the second DC power supply 10b.

As described above, in the PB mode, the system voltage VH can be adjusted to the voltage command value VH* after the DC/DC conversion is performed for inputting or outputting the DC power in parallel between the DC power supplies 10a, 10b and the power line 20. Further, in accordance with the current command value for a DC power supply targeted for current control (power control), the input/output power relative to the pertinent DC power supply can be controlled.

In the PB mode, the amount of power that is equivalent to a shortage of the power, which the DC power supply targeted for the current control outputs with respect to the input/output power of the load 30 (hereinafter also referred to as load power PL), is output from the DC power supply targeted for the voltage control. Therefore, a power distribution ratio for the DC power supplies can be indirectly controlled by setting the current command value for current control. As a result, in the PB mode, the total electric power PH (PH=Pa+Pb), which both the DC power supplies 10a and 10b input or output relative to the power line 20, can be divided, under the control, into power for the DC power supply 10a and power for the DC power supply 10b. Furthermore, the operation for charging one of the DC power supplies 10a and 10b by utilizing power output by the other DC power supply can also be performed by setting the current command value. In the following description, the power values of the output power Pa and Pb, the total power PH, and load power PL are represented as positive values employed for discharging of the DC power supplies 10a and 10b and for power running for the load 30, or are represented as negative values for charging of the DC power supplies 10a and 10b and for regeneration for the load 30.

### (Voltage Step-up Operation in the aB Mode and the bB Mode)

The step-up operation for the Dc power supply 10a in the aB mode is performed in the same manner as the step-up operation explained for the PB mode. That is, bidirectional DC/DC conversion (step-up operation) between the DC power supply 10a and the power line 20 is performed by alternately repeating the switching operations shown in FIGS. 4A and 4B in accordance with the duty ratio Da. When the aB mode is employed, the voltage VH output to the power line 20 (i.e., the voltage command value VH*) is set at substantially the same level as the voltage Vb of the DC power supply 10b, so that the DC power supply 10b can be set unused by inhibiting the input/output to the DC power supply 10b.

The step-up operation for the DC power supply 10b in the bB mode is performed in the same manner as the step-up operation explained for the PB mode. That is, in the bB mode, bidirectional DC/DC conversion (step-up operation) between the DC power supply 10b and the power line 20 is performed by alternately repeating the switching operations shown in FIGS. 5A and 5B in accordance with the duty ratio Db. When the bB mode is employed, the voltage VH output to the power line 20 (i.e., the voltage command value VH*) is set at substantially the same level as the voltage Va of the DC power supply 10a, so that the DC power supply 10a can be set unused by inhibiting the input/output to the DC power supply 10a.

### (Step-Up Operation in the SB Mode)

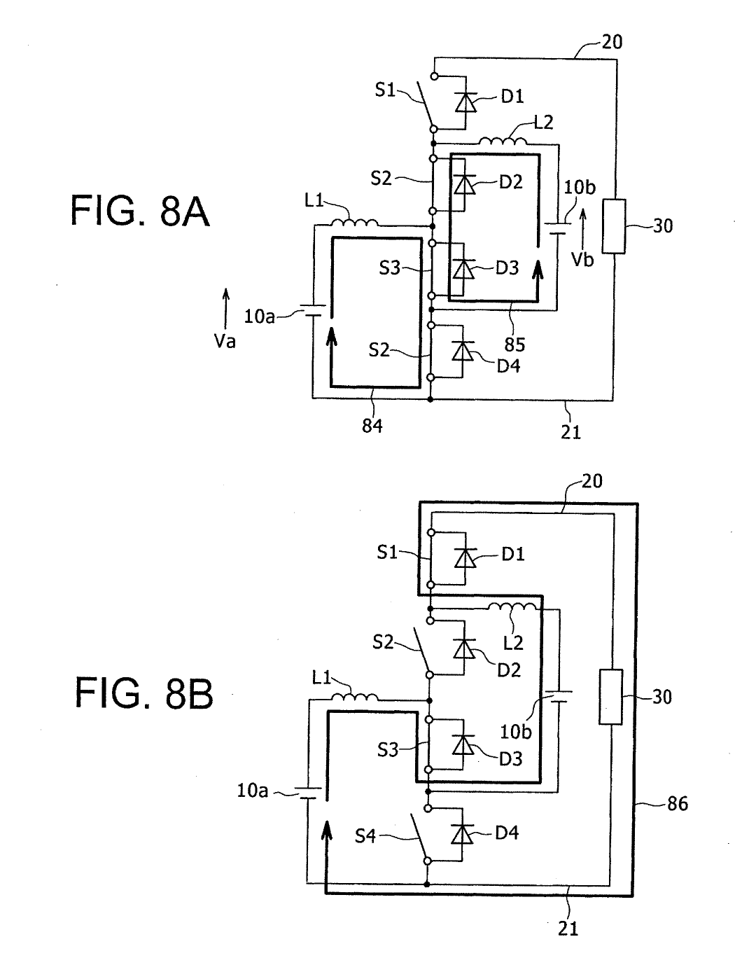

The step-up operation in the SB mode will now be described while referring to FIGS. 8A and 8B. As shown in FIG. 8A, the switching element S3 is held in the ON state to connect the DC power supplies 10a and 10b in series, while the two switching elements S2 and S4 are turned on, and the switching element S1 is turned off. Thus, current paths 84 and 85 used to accumulate energy in the reactors L1 and L2 are formed. As a result, the ON state of the lower arm elements of the step-up chopper circuits is provided for the DC power supplies 10a and 10b connected in series.

In contrast, as shown in FIG. 8B, the switching element S3 is held in the ON state, while in the manner opposite to that shown in FIG. 8A, the two switching elements S2 and S4 are turned off, and the switching element S1 is turned on. Thus, the ON state of the upper arm elements of the step-up chopper circuits is provided for the DC power supplies 10a and 10b connected in series. As a result, the sum of energy output by the DC power supplies 10a and 10b connected in series and the energy accumulated in the reactors L1 and L2 is output to the power line 20.

The current paths 84 and 85 in FIG. 8A and a current path 86 in FIG. 8B are alternately formed by alternately repeating a first period, in which the two switching elements S2 and S4 are turned on and the switching element S1 is turned off, while the switching element S3 is held in the ON state, and a second period, in which the switching element S1 is turned on and the switching elements S2 and S4 are turned off.

For the DC/DC conversion in the SB mode, a relationship represented by expression (3) below is established for the voltage Va of the first DC power supply 10a, the voltage Vb of the second DC power supply 10b, and the system voltage VH of the power line 20. In expression (3), a duty ratio in the first period where the two switching elements S2 and S4 are turned ON is denoted by Dc.

VH=1/(1−Dc)·(Va+Vb) (3)

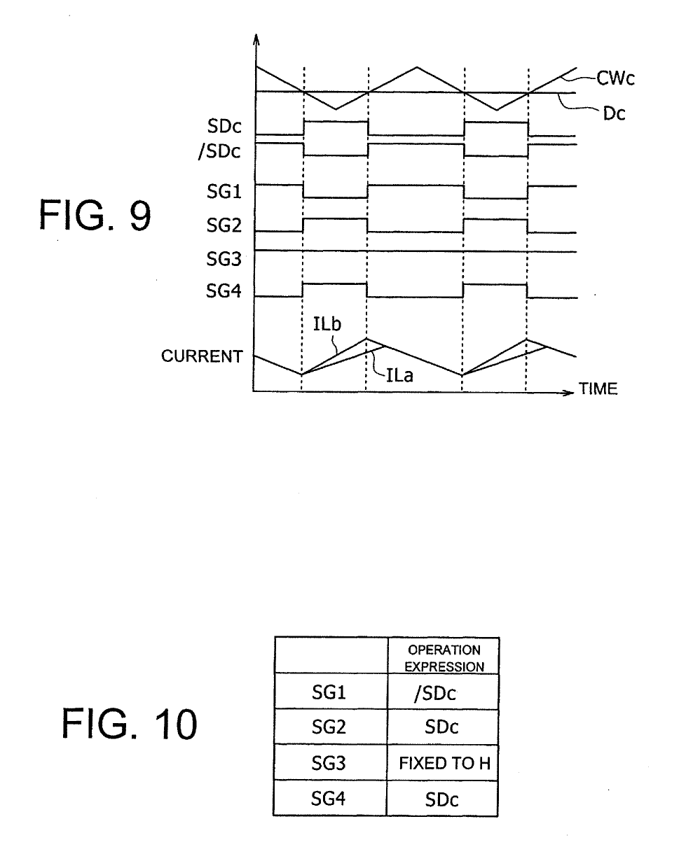

FIG. 9 is a waveform diagram for explaining an example operation for controlling the switching elements in the SB mode. In the SB mode, the duty ratio Dc in expression (3) is calculated to compensate for a voltage deviation ΔVH (AVH=VH*−VH) of the system voltage VH from the voltage command value VH*. Thereafter, a control pulse signal SDc is generated based on a voltage comparison between a carrier wave CWc and the duty ratio Dc. A control pulse signal /SDc is an inversion signal of the control pulse signal SDc. In the SB mode, the step-up chopper circuit in FIG. 8A or 8B performs DC/DC conversion between the DC voltage (Va+Vb) and the system voltage VH.

As shown in FIG. 10, the control signal SG3 is held at the H level in order to hold the ON state of the switching element S3, as described above. In contrast, the control signals SG1, SG2, and SG4 can be set based on the logical sum of the control pulse signal SDc (/SDc). The control pulse signal SDc is regarded as each of the control signals SG2 and SG4 for the two switching elements S2 and S4 that form the lower arm element of the step up chopper. Likewise, the control signal SG1 of the switching element S1 that forms the upper arm element of the step-up chopper is obtained based on the control pulse signal /SDc. As a result, the period in which the switching elements S2 and S4 that form the lower arm element are turned on and the period in which the switching element S1 that forms the upper arm element are provided in the reverse manner.

In the SB mode, bidirectional DC/DC conversion for the DC power supplies 10a and 10b and the power line 20 is performed in the state wherein the DC power supplies 10a and 10b are connected in series. Therefore, the output power Pa of the DC power supply 10a and the output power Pb of the DC power supply 10b cannot be directly controlled. That is, the ratio of the output power Pa and Pb of the DC power supplies 10a and 10b is automatically determined by expression (4) using the ratio of the voltages Va and Vb. It should be noted that, in the same manner as in the PB mode, the sum (Pa+Pb) of the power output by the DC power supplies 10a and 10b is input to, or output from, the load 30.

Pa/Pb=Va/Vb (4)

### (Step-Up Operation in the PBD Mode)

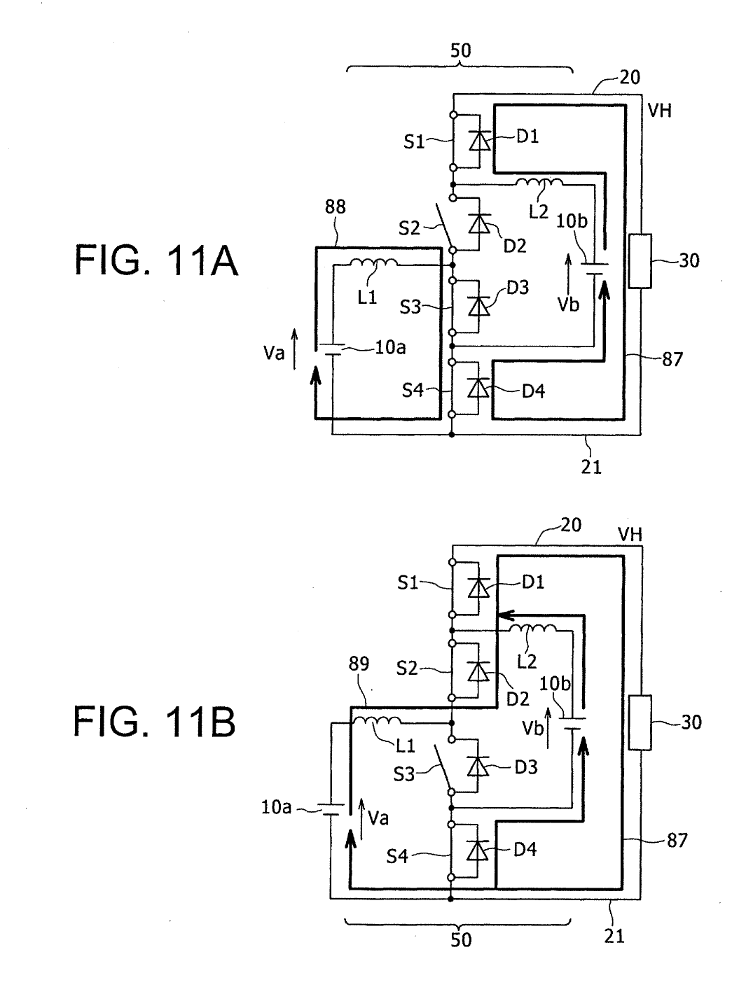

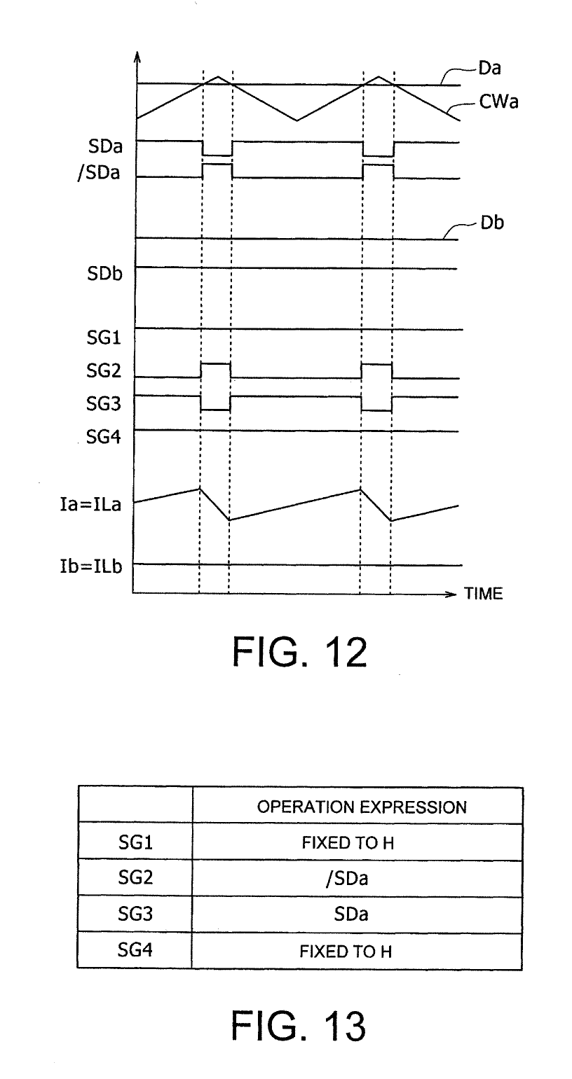

The step-up operation in the PBD mode will now be described in detail, while referring to FIGS. 11A and 11B and FIG. 12. The states in FIGS. 11A and 11B represent DC/DC conversion (set-up operation) for the DC power supply 10a and direct connection of the DC power supply 10b to the power line 20, in parallel to the DC power supply 10a in the PBD mode.

In the PBD mode, the switching elements S1 and S4 are held in the ON state as shown in FIGS. 11A and 11B. In this state, the DC power supply 10b is directly connected to the power line 20. As a result, there is set a current path 87 along which a current flows from the DC power supply 10b through the reactor L2, the diode D1 and the switching element S1, the power line 20, the load 30, the ground line 21, the diode D4, and the switching element S4, and returns to the DC power supply 10b.

A current can flow across the diodes D1 and D4 along the current path 87. Therefore, in the PBD mode, the current path 87 may also be formed by simply connecting the DC power supply 10b directly to the power line 20, without the switching elements S1 and S4 being held in the ON state. Therefore, when only the output operation of the DC power supply 10b is taken into account, on-off control for the switching elements S1 and S4 may be performed in the same manner for the other switching elements S2 and S3 during the step-up operation for the DC power supply 10b, which will be described below. It should be noted, however, that when the switching elements S1 and S4 are in the OFF state, a current path along which power regenerated by the load 30 is supplied to the DC power supply 10b for charging is not formed. Therefore, in this embodiment, the switching elements S1 and S4 are held in the ON state to obtain a path for supplying regenerative power to charge the DC power supply 10b.

As described above, since the DC power supply 10b is directly connected to the power line 20 in the PBD mode, the voltage Vb of the DC power supply 10b is output to the power line 20, without DC/DC conversion (DC voltage conversion) for the voltage Vb being performed. As a result, the system voltage VH of the power line 20 becomes substantially equal to the voltage Vb of the DC power supply 10b. Therefore, the system voltage VH of the power line 20 cannot be controlled. Thus, the PBD mode is an operating mode applicable for a case wherein the voltage command value VH* for the system voltage VH of the power line 20, which is determined based on the electric power demanded by the load 30, is equal to or lower than the voltage Vb of the DC power supply 10b. When the voltage Va of the DC power supply 10a is higher than the voltage Vb of the DC power supply 10b (Va>Vb), the operation in the PBD mode may be performed by directly connecting the DC power supply 10a to the power line 20, and by performing the step-up operation for the DC power supply 10b.

As for between the DC power supply 10a and the power line 20, the step-up operation is performed in the same manner as the operation in the PB mode described while referring to FIGS. 4A to 6. As shown in FIG. 11A, the switching element S3 is turned on and the switching element S2 is turned off to form a current path 88 used to accumulate energy in the reactor L1. Thus, the ON state of the lower arm element of the step-up chopper for the DC power supply 10a is established.

In contrast, as shown in FIG. 11B, the switching element S3 is turned off and the switching element S2 is turned on to form a current path 89 used to output the energy accumulated in the reactor L1, together with the energy of the DC power supply 10a. As a result, the ON state of the upper arm element of the step-up chopper for the DC power supply 10a is established.

When the first period in which the switching element S3 is ON and the switching element S2 is OFF and the second period in which the switching element S2 is ON and the switching element S3 is OFF are alternately repeated, the step-up chopper for the DC power supply 10a is provided.

The performance of DC/DC conversion in FIGS. 11A and 11B is controlled within a voltage range in which the voltage that has been stepped up can be regarded as equal to the voltage Vb of the DC power supply 10b (i.e., the system voltage VH of the power line 20). The “voltage range in which the voltages can be regarded as equal” includes a range used for a case wherein the voltage that has been stepped up is slightly higher than the voltage Vb of the DC power supply 10b and a range used for a case wherein the voltage that has been stepped up is slightly lower. When the voltage that has been stepped up for the DC power supply 10a is set slightly higher than the voltage Vb of the DC power supply 10b, the current Ib flowing from the DC power supply 10b is reduced, while the current Ia that flows from the DC power supply 10a is increased, so that the total current (Ia+Ib) that flows across the power line 20 is increased. As a result, the total power PH supplied to the load 30 is increased.

In contrast, when the voltage that has been stepped up for the DC power supply 10a is set slightly lower than the voltage Vb of the DC power supply 10b, the current Ia that flows from the DC power supply 10a is reduced by the amount equal to or greater than the increase in the current from the DC power supply 10b, and accordingly, the total current (Ia+Ib) that flows along the power line 20 is reduced. As a result, the total power PH supplied to the load 30 is reduced.

The voltage that has been stepped up for the DC power supply 10a in the PBD mode can be controlled by adjusting the duty ratio Da employed during the period in which the switching element S3 that is a constituent of the lower arm element of the step-up chopper is ON. That is, when the duty ratio of the switching element S3 is adjusted, the power Pa supplied to the power line 20 by the DC power supply 10a can be controlled, and also a power distribution ratio for the DC power supplies 10a and 10b can be controlled within a predetermined range. As with the case for the PB mode, a relationship represented by the above-mentioned expression (1) including the duty ratio Da is established between the voltage Va of the DC power supply 10a and the system voltage VH of the power line 20 in the PBD mode.

FIG. 12 is a waveform diagram for explaining an example operation for controlling the switching elements in the PBD mode. Referring to FIG. 12, in the PBD mode of this embodiment, the output of the DC power supply 10b is regarded as the system voltage VH, and current control (power control) for the output of the DC power supply 10a is performed to compensate for the current deviation of the current Ia. At this time, the command value (Ia*) for the current control can be set to control the output power of the DC power supply 10a. In this case, the duty ratio Da is calculated based on the current deviation ΔIa (ΔIa=Ia*−Ia).

A control pulse signal SDa is generated based on the results of voltage comparison between the duty ratio Da, for controlling the output of the DC power supply 10a, and a carrier wave CWa. A control pulse signal /SDa is an inversion signal of the control pulse signal SDa. Whereas, since the switching elements S1 and S4 are maintained in the ON state, the duty ratio Db of the switching elements S1 and S3 that correspond to the upper arm elements is set to a fixed value of zero. As a result, as shown in FIG. 13, the control signals SG1 and SG4 are fixed to level H, and the so-called “ON state of the upper arm” is provided.

As apparent from FIGS. 12 and 13 for the PBD mode, since the control signals SG2 and SG3 are signals inverted from each other, the switching elements S2 and S3 are turned on or off to provide the states opposite to each other. Further, the control signals SG1 and SG4 are maintained in the ON state. As a result, the DC conversion operation based on the duty ratio Da can be performed for the DC power supply 10a.

In the PBD mode, the electric power is output by the DC power supply 10b directly connected in order to compensate for a shortage, relative to the load power PL, of output power of the DC power supply 10a, for which the current control is performed. Therefore, the current command value for the current control is set to enable indirect control for the ratio of power distribution for the DC power supplies 10a and 10b. As a result, in the PBD mode, power distribution is controlled for electric power of the DC power supplies 10a and 10b, for the total power PH (PH=Pa+Pb) that is input to/output from the power line 20 by the two DC power supplies 10a and 10b. Further, when the current command value is set, the operation for charging one of the DC power supplies by using the power output by the other DC power supply can also be performed.

### (Operating Mode Selection Processing)

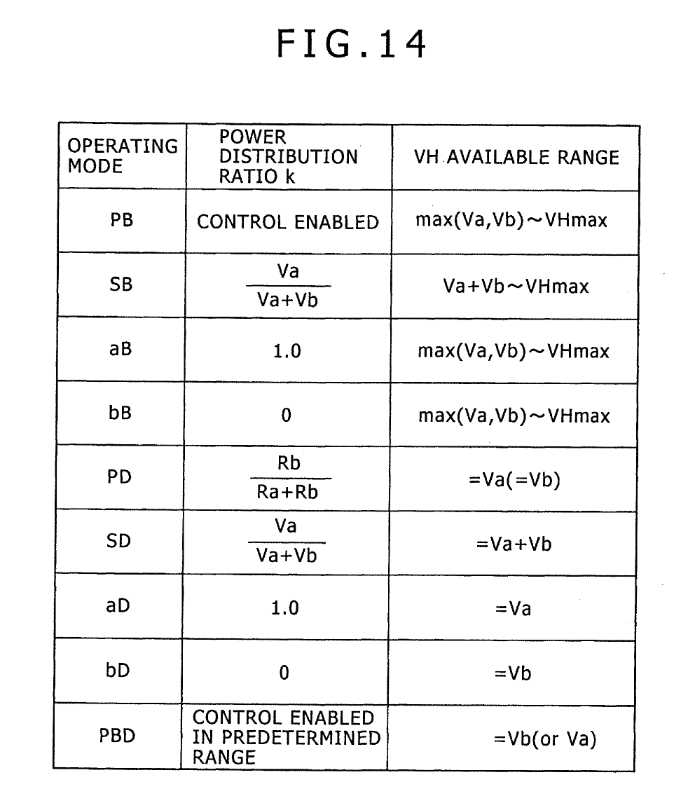

The operating mode selection processing in this embodiment to control the power converter will now be described. In FIG. 14, a table shows, for the individual operating modes, the control enabled or disabled for the power distribution ratio k for the DC power supplies 10a and 10b and a range available for setting the system VH.

Referring to FIG. 14, in the PB mode, the power distribution ratio k for the DC power supplies 10a and 10b can be controlled by setting the current command value for a DC power supply targeted for the current control. Here, the power distribution ratio k (k=Pa/PH) is defined as a ratio of the output power Pa of the DC power supply 10a to the total power PH (PH=Pa+Pb). That is, in the PB mode, the power distribution ratio k can be set to an arbitrary value in a range of 0 to 1.0. It should be noted that, in the PB mode, the system voltage VH can be adjusted within a range from the maximum value max(Va, Vb) for the voltages Va and Vb to the upper limit voltage VHmax that is the upper limit value for controlling the system voltage VH. In this case, when Va>Vb, max(Va, Vb)=Va is established, whereas when Vb>Va, max(Va, Vb)=Vb is established. The upper voltage VHmax represents the upper limit value determined by taking, for example, withstanding voltages of parts of the system 1 into account.

In contrast, in the PBD mode, the power distribution ratio k for the DC power supplies 10a and 10b can also be controlled by setting the current command value Ian for the DC power supply 10a that is a target for current control. It should be noted that, unlike the PB mode that can control, separately, the individual duty ratios for the DC power supplies 10a and 10b, there is a restriction for the PBD mode that the voltage that has been stepped up for the Dc power supply 10a should be set substantially equal to the voltage Vb of the DC power supply 10b output to the power line 20. Therefore, the power distribution ratio k is set within a range smaller than the range of the PB mode. Furthermore, in the PBD mode, the system voltage VH of the power line 20 is uniquely determined to be the voltage Vb of the DC power supply 10b that is directly connected to the power line 20.

As for the other operating mode, the power distribution ratio k is 1 or 0 for the aB mode, the bB mode, the aD, mode and the bD mode, each of which uses only one of the DC power supplies. Further, since the power distribution ratio k for the SB mode and the SD mode is uniquely determined based on the ratio of the voltages Va and Vb of the individual DC power supplies 10a and 10b, control of power distribution cannot be performed. Further, since the power distribution ratio for the PD mode is uniquely determined based on the ratio of internal resistances Ra and Rb of the DC power supplies 10a and 10b that are directly connected in series, the power distribution control cannot be performed also in this case.

In the power system 1, the system voltage VH to be supplied to the load 30 is set in accordance with the operating state of the load 30, such as the torque or the rotation speed. In a case, as shown in the example in FIG. 2, wherein the load 30 is the motor generator 35 that is mounted as a drive force generator to an electric vehicle, a load demanding voltage VHrq of the motor generator 35 is set based on, for example, the vehicle speed or the accelerator position. The system voltage VH of the power line 20, which is a voltage to be supplied to the load 30, should be set at a level equal to or higher than the load request voltage VHrq. Therefore, the operating mode applicable for the power converter 50 varies in accordance with the range of the load demanding voltage VHrq that is set in accordance with the operating state of the load 30.

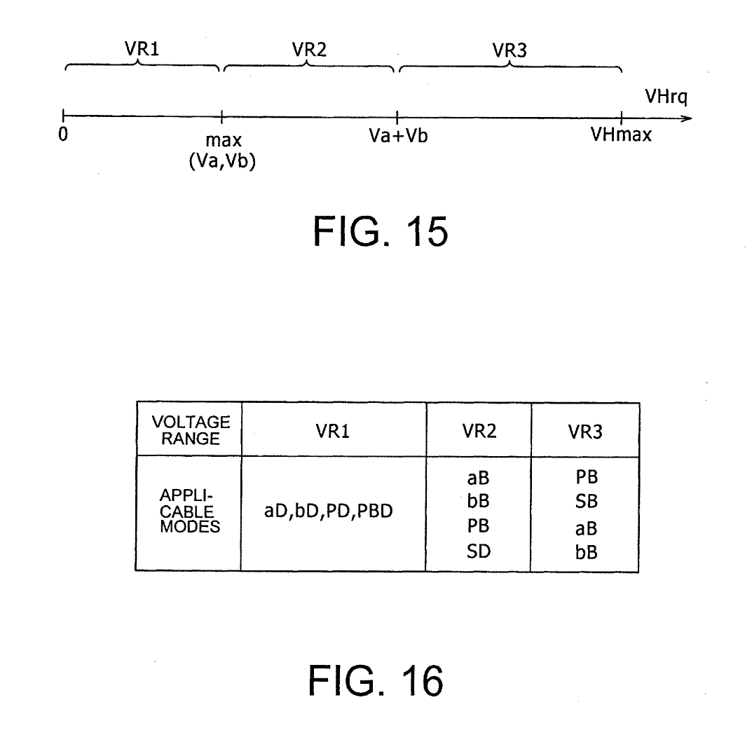

The definitions of voltage ranges VR1 to VR3 of the load demanding voltage VHrq are shown in FIG. 15. FIG. 16 is a table for explaining the selection of the operating modes VR1-VR3 for the individual voltage ranges.

Referring to FIG. 15, the load demanding voltage VHrq is set to one of the voltage ranges, VR1 (VHrq≦max(Va, Vb)), VR2 (max(Va, Vb)<VHrq≦Va+Vb), and VR3 (Va+Vb<VHrq≦VHmax).

The power converter 50 cannot output a voltage lower than max(Va, Vb), and therefore, when the load demanding voltage VHrq is within the voltage VR1, the system VH cannot coincide with the load demanding voltage VHrq. Therefore, as shown in FIG. 16, the aD mode, the bD mode, the PD, mode and the PBD mode are selected as operating modes applicable for the voltage range VR1, in order to bring the system voltage VH closer to the load demanding voltage VHrq in the range VH VHrq.

In the aB mode, the bB mode, and the PB mode, excluding the PBD mode, which are categorized into the boost modes, the system voltage VH can be controlled in accordance with the voltage command value VH* so long as the system voltage VH falls within the range of max(Va, Vb) to VHmax. In contrast, in the SB mode, the system voltage VH cannot be adjusted below (Va+Vb). That is, so long as the system voltage VH is within the range of (Va+Vb) to VHmax, the system voltage VH can be controlled in accordance with the voltage command value VH*.

For the voltage range VR2, the aB mode, the bB mode, and the PB mode are selected as applicable operating modes by taking into account the ranges available for controlling the system VH in the individual operating modes. When these operating modes are employed, the system voltage VH can coincide with the load demanding voltage VHrq by establishing VH*=VHrq. On the other hand, the aD mode, the bD mode, the PD mode, and the PBD mode cannot be employed, because the voltage level is insufficient.

Since the condition of VH VHrq is satisfied in the SD mode, the SD mode can be employed for the voltage range VR2. In the SD mode, the system VH (VH=Va+Vb) cannot coincide with the load demanding voltage VHrq, but since switching is not performed, the loss at the power converter 50 can be greatly reduced. Therefore, the total loss of the power supply system 1 may be reduced to a greater extent than when the aB mode, the bB mode, or the PB mode is employed. Thus, the SD mode can be included as the operating mode applicable for the vulgate range VR2. In other words, since a difference between the system VH and the load demanding voltage VHrq and the loss at the power converter 50 in the SB mode are greater than those in the SD mode, the SB mode is excluded from the operating modes applicable for the voltage range VR2.

For the voltage range VR3, the PB mode, the SB mode, the aB mode, and the bB mode are selected as applicable operating modes by taking into account the ranges available for controlling the system VH in the individual operating modes. When these operating modes are employed, the system voltage VH can coincide with the load demanding voltage VHrq by establishing VH*=VHrq. On the other hand, the direct connection modes (the aD mode, the bD mode, the PD mode, and the SD mode) and the PBD mode cannot be employed because the voltage level is insufficient.

Referring to FIG. 16, a plurality of operating modes are included for the individual voltage ranges VR1, VR2, and VR3. The controller 40 selects and employs one of these operating modes. At this time, based on the load demanding voltage VHrq, which is determined in accordance with the operating state of the load 30, and the power supply states (e.g., the SOC or the charging/discharging limitation) of the DC power supplies 10a and 10b, the controller 40 can select one of the operating modes to minimize the total loss of the power supply system 1. The power supply states are, for example, the voltages Va and Vb, the currents Ia and Ib, and the temperatures Ta and Tb. Furthermore, the total power PH and the power distribution ratio k can be employed to obtain the output powers Pa and Pb of the DC power supplies 10a and 10b.

An explanation will be specifically given for an example wherein the controller 40 selects one of the operating modes by taking the total loss of the power supply system 1 into account. The loss of the power supply system 1 includes a converter loss Plcv that occurs in the power converter 50, a load loss Plld that occurs in the load 30, and a power loss Plps that occurs due to the internal resistances Ra and Rb of the DC power supplies 10a and 10b.

The converter loss Plcv includes a switching loss, which is caused by the ON/OFF control of the switching elements S1 to S4, and a core loss of the reactors L1 and L2. However, in the direct connection modes, such as the aD mode, the bD mode, the SD mode, and the PD mode, the switching loss does not occur, because the switching elements S1 to S4 are held in the ON or OFF state. Therefore, in this case, the converter loss Plcv is proportional to the current that passes through the reactors L1 and L2 of the power converter 50.

The converter loss Plcv can be estimated for each applicable operating mode in accordance with a loss map or an arithmetic expression that is set in advance as a function for the load demanding voltage VHrq (or the system voltage VH) and the voltages Va and Vb and the output powers Pa and Pb of the DC power supplies 10a and 10b. In this case, the output powers Pa and Pb can be obtained by employing the total power PH (PH=Pa+Pb) and the power distribution ratio k. Specifically, Pa=PH×k and Pb=PH×(1−k) can be employed to obtain the output powers Pa and Pb. The power distribution ratio k in this case can be determined by, for example, referring to a loss map that is prepared in advance based on, for example, the states of the DC power supplies 10a and 10b (e.g., SOC balancing or balancing for charge/discharge limits) or the output power levels (PH). It should be noted that the loss map or the arithmetic expression can be obtained in advance based on experimental results or simulation results. This also applies for the other losses described below.

The load loss Plld can be estimated for each applicable operating mode in accordance with a loss map or an arithmetic expression that is set in advance as a function for the load demanding voltage VHrq (or the system voltage VH) and the operating state of the load 30, including a torque and a rotation speed.

The power loss Plps can be estimated for each applicable operating mode in accordance with a loss map or an arithmetic expression that is set in advance as a function for the internal resistances Ra and Rb and the voltages Va and Vb of the DC power supplies 10a and 10b and the total power PH. Since the internal resistances Ra and Rb of the DC power supplies 10a and 10b are varied in accordance with the states of the DC power supplies 10a and 10b (e.g., the temperatures Ta and Tb and SOCa and SOCb), the present power supply states are employed to estimate the internal resistances Ra and Rb based on the loss map or the arithmetic expression.

The controller 40 calculates, for each applicable operating mode, the sum of the converter loss Plcv, the load loss Plld, and the power loss Plps thus estimated, and compares these losses. Then, the controller 40 selects one of the multiple applicable operating modes, for which the sum of the power losses is the smallest. When the power converter 50 is controlled by employing the selected operating mode, the total loss of the power system 1 can be minimized to thereby improve the efficiency.

### (Power Converter Control Performed by a Controller)

FIG. 17 is a diagram for explaining the basic concept of power converter control performed by the power supply system 1 of this embodiment. Referring to FIG. 17, the system voltage VH is increased under the condition that the total power PH is higher than the load power PL (PH>PL), or is reduced under the condition of PH<PL. Therefore, for the power converter control in this embodiment, the command value for the total power PH is set in accordance with the voltage deviation ΔVH with respect to the voltage command value VH* of the system voltage VH. Further, the total power PH is divided into the power Pa and the power Pb, and thereby the power control for the outputs of the DC power supplies 10a and 10b is performed.

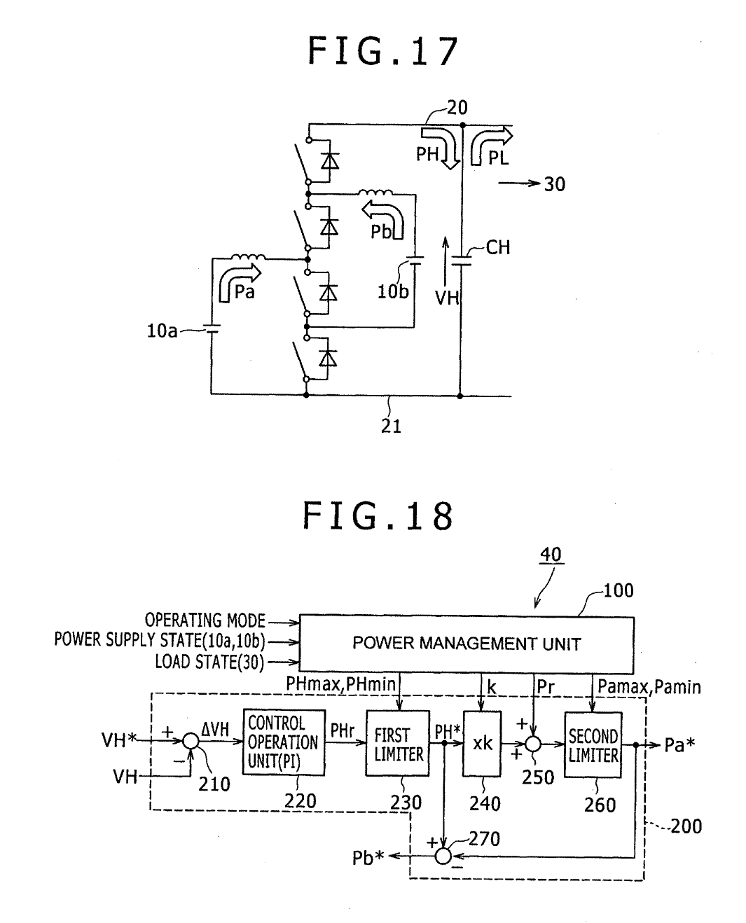

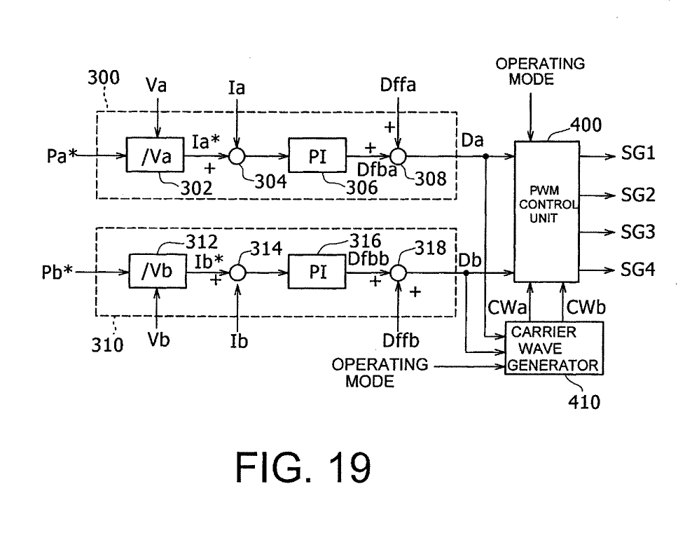

FIGS. 18 and 19 are block diagrams for explaining the power converter control performed for this embodiment. The arrangement for the control operation to set the power command values for the individual power supplies is shown in FIG. 18, and the arrangement for the control operation to control the outputs of the DC power supplies based on the power command values that have been set is shown in FIG. 19. The control arrangement in the PB mode will be described first, and thereafter, the control processing performed in the other boost modes will be described.

Referring to FIG. 18, the controller 40 includes a power management unit 100 and a power control unit 200.

The power management unit 100 sets, based on the operating states of the DC power supplies 10a and 10b and/or the operating state of the load 30, an upper power limit PHmax and a lower power limit PHmin for the total power PH, a discharge limit Paout and a charge limit Pain of the DC power supply 10a, a discharge limit Pbout and a charge limit Pbin of the Dc power supply 10b, and a power distribution ratio k for the DC power supplies 10a and 10b. At this time, the upper power limit PHmax of the total power PH can be set as the sum of the discharge limits Paout and Pbout of the DC power supplies 10a and 10b (PHmax=Paout+Pbout). The lower power limit PHmin of the total power PH can be set as the sum of the charge limits Pain and Pbin of the DC power supplies 10a and 10b (PHmin=Pain+Pbin).

Further, the power management unit 100 can set the power distribution ratio k. As described above, in the PB mode, the power distribution ratio k can be set to an arbitrary value in a range of 0≦k≦1.0, and in the PBD mode, the power distribution ratio k can be set in a predetermined range narrower than the above range.

The power management unit 100 can also set a circulating power value Pr to perform charging/discharging between the Dc power supplies 10a and 10b. The circulating power value Pr corresponds to power output by the DC power supply 10a in order to charge the DC power supply 10b. For example, when Pr>0 is set with k=1 for the power running of the motor generator 35, the total power PH is supplied to the power line 20 by employing the power output by the DC power supply 10a, and at the same time, charging of the DC power supply 10b can be performed. In contrast, when Pr<0 is set with k=0, the total power PH can be supplied to the power line 20 by employing the output of the DC power supply 10b, and at the same time, the DC power supply 10a can be charged.

Furthermore, when Pr>0 is set with k=0 for regenerative operation (PH<0) of the motor generator 35, the DC power supply 10b can be charged by employing both the regenerative power of the load 30 and the power output by the DC power supply 10a. In contrast, when Pr<0 is set with k=1, the DC power supply 10a can be charged by employing both the regenerative power of the load 30 and the power output by the DC power supply 10b.

Whereas, when the circulating power value Pr is not set (Pr=0), charging/discharging is not performed between the DC power supplies 10a and 10b. In a case wherein, for example, there is an imbalance in the SOC of the DC power supplies 10a and 10b, the power management unit 100 can set the circulating power value Pr to encourage charging of the DC power supply on the low SOC side.

The power control unit 200 sets the power command values Pa* and Pb* of the DC power supplies 10a and 10b based on the voltage deviation of the system voltage VH. The power control unit 200 includes a deviation calculation unit 210, a control operation unit 220, a first limiter 230, a power distribution unit 240, a circulating power addition unit 250, a second limiter 260, and a subtraction unit 270.

The deviation calculation unit 210 calculates the voltage deviation ΔVH (ΔVH=VH*−VH) that is a difference between the voltage command value VH* and a detection value for the system voltage VH. The control operation unit 220 employs the voltage deviation ΔVH to calculate the total power PHr requested for the voltage control. For example, the control operation unit 220 performs PI operation to set the total power PHr in accordance with expression (5) below.

PHr=Kp·ΔVH+Σ(Ki·ΔVH) (5)

Kp in expression (5) is a proportional control gain, and Ki is an integral control gain. The capacitance of the smoothing capacitor CH is reflected to these control gains. The total power PHr is set in accordance with expression (5), and thereby feedback control for reducing the voltage deviation ΔVH can be provided.

The first limiter 230 limits the power command value PH*, so that the power command value PH* falls within the range of PHmax to PHmin that is set by the power control unit 100. In a case wherein PHr>PHmax, the first limiter 230 sets the power command value PH* as PH*=PHmax. Likewise, when PHr<PHmin, the first limiter 230 sets PH*=PHmin. Further, when PHmax PHr PHmin, the power command value PH* is set as PH*=PHr without any change. As a result, the total power command value PH* is established.

The power distribution unit 240 calculates, based on the total power command value PH* and the power distribution ratio k, the output power k·PH* to be assigned to the DC power supply 10a. The circulating power addition unit 250 adds the output power k·PH*, obtained by the power distribution unit 240, to the circulating power value Pr, set by the power management unit 100, and obtains the power Par requested for the DC power supply 10a (Par=k·PH*+Pr).

The second limiter 260 limits the power command value Pa* for the DC power supply 10a, so that the power command value Pa* falls within the range of Paout to Pain that is set by the power management unit 100. In a case wherein Par>Paout, the second limiter 260 modifies the power command value Pa* as Pa*=Paout. Likewise, when Par<Pain, the second limiter 260 modifies the power command value as Pa*=Pain. Further, when Paout≧Par≧Pain, the power command value Pa* is set as Pa*=Par without any change. As a result, the total power command value Pa* for the DC power supply 10a is established.

The subtraction unit 270 subtracts the power command value Pa* from the total power command value PH* to set the power command value Pb* of the DC power supply 10b (Pb*=PH*−Pa*).

As shown in FIG. 19, the controller 40 includes: current control units 300 and 310, a PWM control unit 400, and a carrier wave generator 410, that control the outputs of the DC power supplies 10a and 10b based on the power command values Pa* and Pb*. The current control unit 300 controls the output of the DC power supply 10a by performing current control. The current control unit 310 controls the output of the DC power supply 10b by performing current control.

The current control unit 300 includes a current command generator 302, a deviation calculation unit 304, a control operation unit 306, and an FF addition unit 308.

The current command generator 302 sets the current command value Ia* for the DC power supply 10a based on the power command value Pa* and the detection value of the voltage Va (Ia*=Pa*/Va). The deviation calculation unit 304 calculates a current deviation ΔIa (ΔIa=Ia*−Ia) that is a difference between the current command value Ia* and a detection value for the current Ia. The control operation unit 306 employs the current deviation ΔIa to calculate a control value Dfba for current feedback control. For example, the control operation unit 306 performs PI (Proportional-Integral) operation to set the control value Dfba in accordance with expression (6) below.

Dfba=Kp·ΔIa+Σ(Ki·ΔIa) (6)

In the expression (6), Kp in expression (6) is a proportional control gain, and Ki is an integral control gain. These control gains are set, separately from those in the above-mentioned expression (5).

The FF control value Dffa for voltage feedfoward control is set by expression (7) below, based on Da=(VH−Va)/VH, which is obtained by solving for Da in the expression (1).

Diffa=(VH*−Va)/VH* (7)

The FF addition unit 308 adds the FB control value Dfba to the FF control value Dffa to obtain the duty ratio Da associated with the output control for the DC power supply 10a. As is the case in the expression (1), the duty ratio Da corresponds to the duty ratio for the period in which the lower arm elements (the switching elements S3 and S4) of the step-up chopper (FIG. 4) are in the ON state when DC/DC conversion is performed from the voltage Va of the DC power supply 10a to the system voltage VH.

The current control unit 310 includes a current command generator 312, a deviation calculation unit 314, a control operation unit 316, and an FF addition unit 318.

The current command generator 312 sets the current command value Ib* for the DC power supply 10b based on the power command value Pb* and the detection value of the voltage Vb (Ib*=Pb*/Vb). The deviation calculation unit 314 calculates a current deviation ΔIb (ΔIb=Ib*−Ib) that is a difference between the current command value Ib* and a detection value for the current Ib. The control operation unit 316 employs the current deviation ΔIb to calculate a control value Dfbb for current feedback control. For example, the control operation unit 316 performs PI operation to set the Dfbb in accordance with expression (8) below.

Dfbb=Kp·ΔIb+Σ(Ki·ΔIb) (8)

In the expression (8), Kp is a proportional control gain, and Ki is an integral control gain. These control gains are set, separately from those in the expressions (5) and (6).

The FF control value Dffb for voltage feedfoward control is set by expression (9) below, based on Db=(VH−Vb), which is obtained by solving for Db in the expression (2).

Diffb=(VH*−Vb)/VH* (9)

The FF addition unit 318 adds the FB control value Dfbb to the FF control value Dffb to obtain the duty ratio Db associated with the output control for the DC power supply 10b. As is the case in the expression (2), the duty ratio Db corresponds to the duty ratio for the period in which the lower arm elements (the switching elements S2 and S3) of the step-up chopper (FIG. 5) are in the ON state when DC/DC conversion is performed from the voltage Vb of the DC power supply 10b to the system voltage VH.

The PWM control unit 400 performs pulse width modulation based on the duty ratios Da and Db, set by the current control units 300 and 310, and the carrier waves Cwa and Cwb output by the carrier wave generator 410, and generates the control signals SG1 to SG4 for the switching elements S1 to S4. Since the pulse width modulation and generation of the control signals SG1 to SG4 by the PWM control unit 400 are performed in the same manner as explained in relation to FIGS. 6 and 7, a detailed explanation for this will not be repeated.

The control for the voltage converter in the boost modes other than the PB mode;

i.e., in the aB mode, the bB mode, the SB mode, and the PBD mode, will now be described.

First, in the aB mode, as in the PB mode, the total power command value PH* is set by the deviation calculation unit 210, the control operation unit 220, and the first limiter 230. In this case, since the DC power supply 10b is unused, the upper power limit PHmax and the lower power limit PHmin provided for the first limiter 230 can be set to be equal to the discharge limit Paout and the charge limit Pain for the DC power supply 10a.

Since only the DC power supply 10a supplies output power in the aB mode, the power distribution ratio k=1 is set. Further, since the DC power supply 10b is unused (charging/discharging avoidance), the circulating power value Pr=0 is fixed. Furthermore, since Pa* (=PH*) is also set in a limited range of the discharge limit value Paout and the charge limit value Pain by the second limiter 260, one of the first and second limiters in this case may be set inactive.

Further, in the arrangement shown in FIG. 19, the current feedback control is performed only for the DC power supply 10a. That is, the current control unit 300 is operated in the same manner as in the PB mode, and generates the duty ratio Da. In contrast, since the boost operation for the DC power supply 10b is not required in the aB mode, the operation of the current control unit 310 can be halted. That is, calculation of the duty ratio Db is not performed.

Subsequently, the control in the bB mode will be described. In the bB mode, the control operation opposite that in the aB mode is performed. That is, since the DC power supply 10a is unused in the bB mode, the upper power limit PHmax and the lower power limit PHmin provided for the first limiter 230 can be set to be equal to the discharge limit Pbout and the charge limit Pbin for the DC power supply 10b. As a result, the total power command value PH* (=Pb*) is limited to Pbin≦PH*≦Pbout.

Since only the DC power supply 10b supplies output power in the bB mode, the power distribution ratio k=0 is set. Further, since the DC power supply 10a is unused (charging/discharging avoidance), the circulating power value Pr=0 is fixed. Moreover, in the arrangement in FIG. 19, the current feedback control is performed only for the DC power supply 10b. That is, the current control unit 310 is operated in the same manner as in the PB mode, and generates the duty ratio Db. In contrast, since the boost operation for the DC power supply 10b is not required for the bB mode, the operation of the current control unit 300 can be halted. That is, calculation of the duty ratio Da is not performed.

Following this, control in the SB mode will be described. As described above, bidirectional DC/DC conversion between the DC power supplies 10a, 10b and the power line 20 is performed in the SB mode, while the DC power supplies 10a and 10b are connected in series. Therefore, the current employed in common flows across the DC power supplies 10a and 10b (Ia=Ib). Thus, direct control cannot be performed for the output power Pa of the DC power supply 10a and the output power Pb of the DC power supply 10b, and the ratio of the output powers Pa and Pb is automatically determined in accordance with the expression (4) and based on the ratio of the voltages Va and Vb (Pa/Pb=Va/Vb).

Moreover, the power distribution ratio k in the SB mode is set in accordance with expression (10) obtained by using the expression (4), and based on the detection values of the voltages Va and Vb of the DC power supplies 10a and 10b.

K=Va/(Va+Vb) (10)

Further, since charging and discharging between the DC power supplies 10a and 10b cannot be performed in the SB mode, the circulating power value Pr=0 is set.

Through the above described control, in the arrangement shown in FIG. 18, the total power command value PH* is set, in the same manner as in the PB mode, based on the voltage deviation ΔVH of the system voltage VH, and the total power command value PH* is set in the range of PHmax to PHmin by the first limiter 230. Furthermore, the total power command value PH* is divided into the power command value Pa* and Pb* in accordance with the power distribution ratio k obtained by the expression (10), (Pa*=k·PH* and Pb*=PH*−Pa*).

Since Ia=Ib is set in the SB mode, the current feedback control is performed only for one of the DC power supplies 10a and 10b. For example, the power control unit 300 performs power feedback control for the DC power supply 10a, for which the power command value Pa* can be directly limited by the second limiter 260.

In contrast, when the control gain of the control operation unit 316; specifically, Kp and Ki in the expression (8), is set to zero, the current feedback control is not to be performed by the current control unit 310. Therefore, the current control unit 310 performs only the feedforward control based on the voltage Vb to calculate the duty ratio Db (Db=Dffb).

Next, control performed in the PBD mode will be described. In the PBD mode, as in the PB mode, based on the power command value VH* and the system voltage VH, the power command value PH* is generated by the deviation calculation unit 210, the control operation unit 220, and the first limiter 230.

However, since the DC power supply 10b is directly connected to the power line 20 in the PBD mode, the power command value PH* cannot be divided at an arbitrary power distribution ratio k (0≦k≦1). That is, since the power distribution is controlled only within the voltage range in which the system voltage VH of the power line 20 is regarded as equal to the voltage Vb of the DC power supply 10b, the output power supplied by the DC power supply 10b is also substantially constant, Pb (i.e., Pb*)=Ib·Vb.

Therefore, when the PBD mode is employed, the power management unit 100 of the controller 40 provides, instead of an arbitrary distribution ratio k in the PB mode, such a power distribution ratio k that the power value obtained by subtracting, from the power command value PH*, the power command value Pb* with which the output of the DC power supply 10b is available, as the power command value Pa* for the DC power supply 10a. As described above, because of this restriction, the power distribution ratio k in the PBD mode falls in the limited range narrower than that in the PB mode.

In the PBD mode, as with the PB mode, the first limiter 230 limits the range to PHmin≦power command value PH*≦PHmax, the circulating power addition unit 250 adds the circulating power Pr to the power command value PH*, and the second limiter 260 limits the range to Pain≦Pa*≦Paout.

The thus generated power command values Pa* and Pb* of the individual DC power supplies 10a and 10b are provided for the control arrangement shown in FIG. 19.

The current control unit 300 performs the current feedback control in the same manner as performed in the PB mode, so that the output power Pa consonant with the power command value Pa* is output by the DC power supply 10a. The DC power supply 10b is connected directly to the power line 20 by holding the ON state of the switching elements S1 and S4 of the power converter 50. Therefore, the operation of the current control unit 310 in FIG. 19 is halted, and DC/DC conversion for the DC power supply 10b is not performed.

As described above, according to the power converter control performed in the embodiment, the control arrangement shown in FIGS. 18 and 19 can be employed in common for the control operation of the power converter 50 in FIG. 1 in the individual operating modes that belong to the boost mode, in which the system voltage VH is adjusted to the power command value VH*. Therefore, the control operation load imposed on the control processing of the power converter 50, for which a plurality of operating modes are selectively employed, can be reduced. Further, since the operating mode can be changed smoothly, the control performance can be improved.

### (Overpower Avoidance Control)

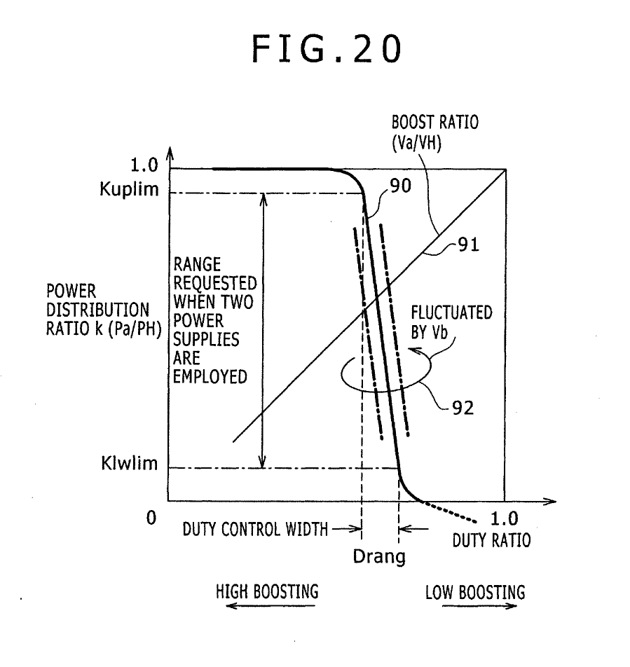

Next, the overpower avoidance control performed by the power supply system 1 of this embodiment will be described, while referring to FIGS. 20 to 23.

FIG. 20 is a graph showing a relationship between the duty ratio for the DC power supply 10a and the power distribution ratio in the PB mode. In this graph, the horizontal axis represents the duty ratio for the ON period of the switching elements S1 and S2 that serve as the upper arm elements of the power converter 50 for the DC power supply 10a. In this case, when the duty ratio is increased toward 1.0, the stepped-up voltage after having stepped the voltage Va of the DC power supply 10a is lowered, and the case of the duty ratio=1 corresponds to the “upper arm ON” state wherein the switching elements S1 and S2 are held ON. Further, this is indicated by a linear line 91, representing that the boost ratio (=Va/VH) becomes 1 (i.e., Va=VH) in proportion to the increase of the duty ratio from 0 to 1.

Further, the vertical axis in the graph in FIG. 20 represents the power distribution ratio k for the DC power supply 10a. In this graph, it is represented that when the power distribution ratio k is 1, the total power PH required as the load power PL is output only by the DC power supply 10a. It is also represented that, when the power distribution ratio k is 0, the total power PL is output only by the DC power supply 10b. At this time, the power distribution ratio k in this embodiment is a ratio of the power command value Pa* of the DC power supply 10a, with respect to the total power command value PH*.

In a case wherein the power supply system 1 is operated in the PB mode, the output power of the DC power supplies must be controlled to prevent a phenomenon that the output power of one of the DC power supplies is excessively larger than the output power of the other DC power supply, such that the overpower state of the pertinent DC power supply, such as overcharge or over-discharge, occurs. Therefore, it is preferable that the input/output power for the individual DC power supplies be maintained in the predetermined range. As for the DC power supply 10a in FIG. 20, the duty ratio for the boost operation should be controlled in the range of the duty control width Drang.

The rate of change of the power distribution ratio k, indicated by a solid line 90 in FIG. 20, fluctuates considerably sharply, compared with the rate of change of the boost ratio indicated by the linear line 91, and therefore, the duty control width Drang to be employed is a small range. Further, the power distribution ratio k is also affected by the fluctuation of the voltage Vb of the DC power supply 10b, and varies in the range indicated by an arrow 92, and accordingly, the applicable duty control width Drang also fluctuates. Therefore, in a case wherein the operation in the PB mode is performed by connecting the two DC power supplies 10a and 10b to the power line 20, it is preferable that the input/output power for the individual DC power supplies 10a and 10b be maintained in the predetermined range, as described above, to appropriately reduce, or prevent, the overpower of the DC power supplies 10a and 10b even in a case wherein the load power PL is suddenly changed (e.g., the case of rapid acceleration of a vehicle).

Therefore, in this embodiment, the following overpower avoidance control is performed to suppress or prevent the occurrence of overpower of the DC power supplies 10a and 10b.

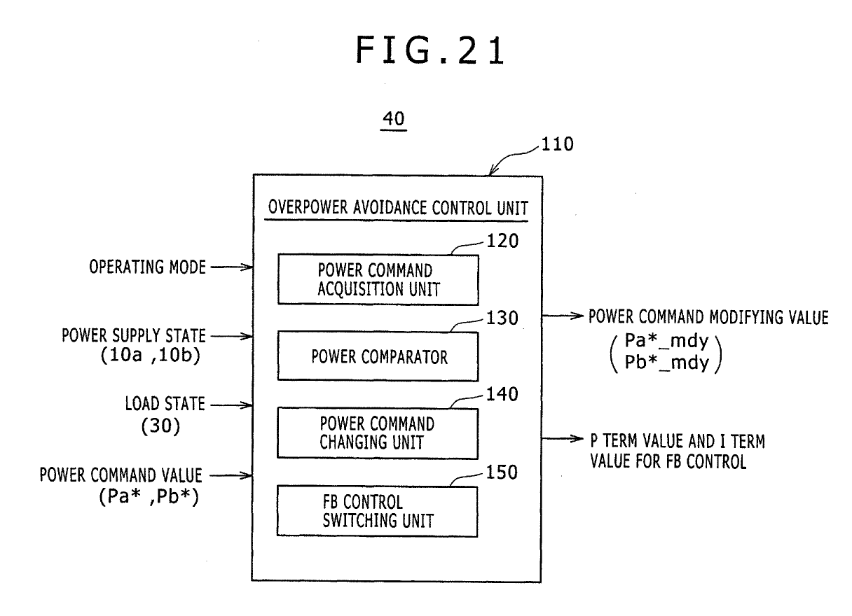

FIG. 21 is a functional block diagram illustrating an overpower avoidance control unit 110 included in the controller 40. The overpower avoidance control unit 110 includes a power command acquisition unit 120, a power comparator 130, a power command changing unit 140, and a feedback control switching unit 150.

The power command acquisition unit 120 has a function for obtaining the power command values Pa* and Pb* distributed into the DC power supplies 10a and 10b, respectively, by the power control unit 200 of the controller 40.

The power comparator 130 has a function for comparing, with power threshold values α and γ or actual power Pa_act and Pb_act, the power command values Pa* and Pb* of the individual DC power supplies 10a and 10b, and a function for comparing, with a power threshold value β, the actual power Pa_act and Pb_act of the DC power supplies 10a and 10b. The power threshold value α corresponds to the lower limit power that is output by another of the DC power supplies when the operating mode (first operating mode) in which the power is supplied only by one of DC power supply is shifted to the operating mode (second operating mode) in which supply of power is performed by using both of the DC power supplies, and the power threshold value γ corresponds to the upper limit power that is output by the another DC power supply. Further, the power threshold value β is a reference determination value, as will be described later, that is used when the feedback control switching unit 150 inhibits or allows the feedback control for the actual power increase side. The power threshold value α corresponds to the lower limit of the input/output power command value of the present invention.

The power threshold values α, β, and γ may be constant values inherent to the DC power supplies 10a and 10b, or may be values that change in accordance with, for example, the SOC or the temperature. The power threshold values α, β, and γ can be obtained based on the experimental results or simulation results, and can be stored in the storage unit (not shown) of the controller 40.

The power threshold values α, β, and γ may also be obtained by using expressions (11) and (12) based on the total power command value PH* and the upper limit kuplim and the lower limit klwlim of the power distribution ratio k, all of which are generated by the power control unit 200 (FIG. 18). In this case, “kuplim” and “klwlim” are the upper limit and the lower limit of the power distribution ratio k of the DC power supply 10a in the PB mode.

α=(1−kuplim)·PH* (11)

γ=(1−klwlim)·PH* (12)

Specifically, in a case wherein the upper limit kuplim of the power distribution ratio k is set to, for example, 0.9, electric power equivalent to 90% of the total command value PH* is output as the upper limit power by the DC power supply 10a, and power equivalent to the remaining 10% is output as the lower limit power by the DC power supply 10b. Therefore, the power threshold value α that corresponds to the lower limit power of the DC power supply 10b in this case is a value equivalent to 10% of the total power command value PH*.

On the other hand, in a case wherein the lower limit klwlim of the power distribution ratio k for the DC power supply 10a in the PB mode is set to, for example, 0.1, electric power equivalent to 90% of the total command value PH* is output as the upper limit power by the DC power supply 10b, and power equivalent to the remaining 10% is output as the lower limit power by the DC power supply 10a. Therefore, the power threshold value α that corresponds to the lower limit power of the DC power supply 10a in this case is a value equivalent to 10% of the total power command value PH*.

An explanation has been given for a case wherein the lower limit power and the upper limit power for the DC power supplies 10a and 10b are the same values (α and γ). However, the upper and lower limits are not limited to the same values, and in accordance with different types or specifications of DC power supplies, the upper limit power α1 and the upper limit power γ1 of the DC power supply 10a may differ from the lower limit power α2 and the upper limit power γ2 of the DC power supply 10b.

The upper limit kuplim and the lower limit klwlim of the power distribution ratio k employed by the power comparator 130 can be obtained by conducting an experiment or simulation, and can be stored in advance in the storage unit (not shown) of the controller 40.

The power command changing unit 140 has a function for changing the power command values Pa* and Pb* of the individual DC power supplies 10a and 10b based on the comparison results provided by the power comparator 130. Specifically, the power command values Pa* and Pb* of the DC power supplies 10a and 10b are set to be equal to or greater than the lower limit power α. In a case wherein the power command values Pa* and Pb* are smaller than the lower power limit α, the power command changing unit 140 changes the Pa* or Pb* to the lower limit power α, and outputs the lower limit power α as the power command modifying value Pa*_mdy (or Pb*_mdy).

The feedback control switching unit 150 has a function that inhibits or allows the feedback control for the power increase side by changing the values of the proportion term and the integration term of the feedback control that is performed by the current control units 300 and 310 (FIG. 19) of the controller 40. Specifically, before the actual power Pa_act and Pb_act of the DC power supplies 10a and 10b reach the power threshold value β or greater, the value of the proportion term is set to be equal or smaller than the preceding value, and the value of the integration term is set to the preceding value, so that the feedback control for the power increase side can be inhibited. The predetermined power threshold value β may be the same value as, or a different value from, the power threshold value α that is obtained by calculating expression (11) based on the total power command value PH* and the lower limit klwlim of the power distribution ratio k.

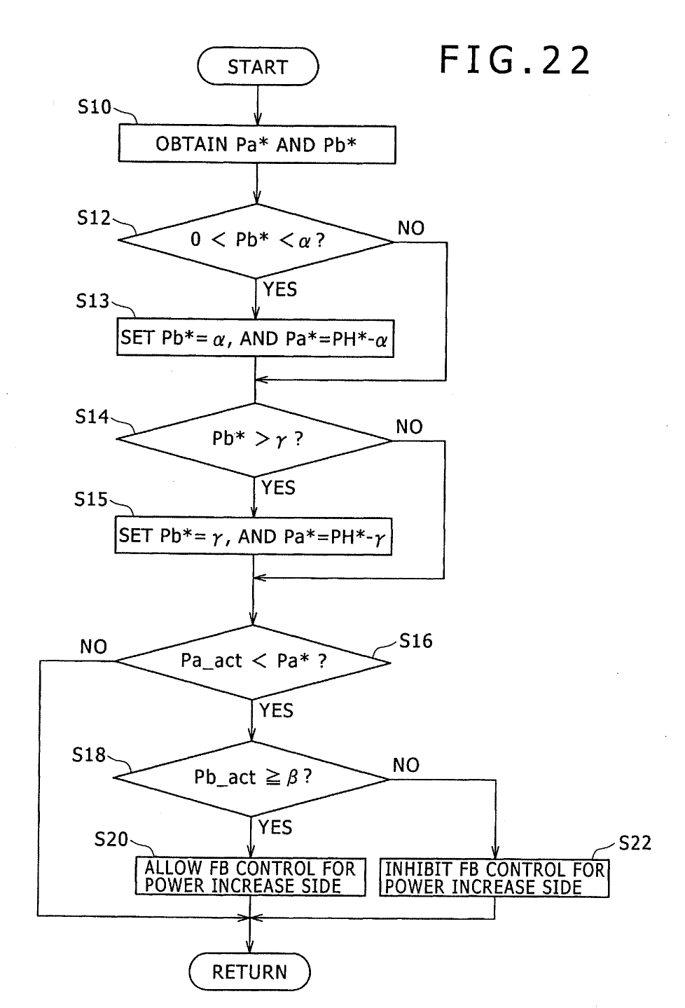

FIG. 22 is a flowchart showing example overpower avoidance control performed by the overpower avoidance control unit 110 in FIG. 21. When the operating mode (e.g. PB mode, etc.) for performing power distribution for the DC power supplies 10a and 10b is selected, this control processing is read from the storage unit of the controller 40 for every predetermined period, and is performed. Further, this control operation can be performed by software processing, and one part of the operation may be provided by using the hardware arrangement (e.g. an electronic circuit).

Further, for the control in FIG. 22, there is shown an example in a case wherein the aB mode for boosting only the output of the DC power supply 10a and supplying the obtained output as the load poseur PL is changed to the PB mode for boosting the outputs of the two DC power supplies 10a and 10b and supplying the obtained outputs as the load power PL. In this case, the DC power supply 10a corresponds to one of the DC power supplies of this invention, and the DC power supply 10b corresponds to another DC power supply of this invention.

Referring to FIG. 22, first, in step S10, the controller 40 obtains the power command values Pa* and Pb* of the individual DC power supplies 10a and 10b. This processing is performed as the function of the power command acquisition unit 120 in FIG. 21.

Following this, in step S12, the controller 40 determines whether the power command value Pb* of the DC power supply 10b is smaller than the predetermined power threshold value α. This processing is performed as the function of the power comparator 130 in FIG. 21. It is to be noted that “0<Pb*” is set in step S12 in FIG. 22, because, as described above, the power value used when electric power is output by the DC power supplies 10a and 10b is represented as a positive value.

When it is ascertained in step S12 that the power command value Pb* of the DC power supply 10b is smaller than the power threshold value α (YES in step S12), in step S13, the power command value Pb*=a of the DC power supply 10b is set, and the power command value Pa*=PH*−α is set. This processing is performed as the function of the power command changing unit 140 in FIG. 21. As a result, the output power command value Pb* of the DC power supply 10b is set to the lower limit power α, and the output power command value Pa* of the DC power supply 10a is set to the upper limit power γ. In contrast, when the decision in step S12 is negative (NO in step S12); i.e., when the power command value Pb* of the DC power supply 10b is equal to or greater than the power threshold value α, the power command values Pa* and Pb* are not changed, and program control advances to step S14. Subsequently, in step S14, the controller 40 determines whether the power command value PB* is greater than the upper limit power γ. When the decision is affirmative (YES in step S14), in step S15, the power command value Pb*=γ of the DC power supply 10b is set, and the power command value Pa*=PH*−γ of the DC power supply 10a is set. In contrast, when the decision in step S14 is negative (NO in step S14), program control advances to step S16. By performing the processes in steps S12 to S15, the output power Pb of the DC power supply 10b is maintained in the power range of α≦Pb≦γ. As a result, the power distribution ratio k for the DC power supplies 10a and 10b is maintained in a desired range of klwlim≦k≦kuplim, so that the occurrence of overpower of the DC power supply 10b can be suppressed or prevented. In the above explanation, the power command value Pb* of the DC power supply 10b is set equal to or smaller than the upper power limit γ by performing the processes in steps S14 and 15; however, these steps S14 and 15 may be omitted. This is because, when one of the power command values Pa* and Pb* of the DC power supplies 10a and 10b is set to be equal or higher than the lower power limit α, the other power command value is set to be equal to or smaller than the upper power limit γ(=PH*−α).

In a case wherein the power command value Pb* of the DC power supply 10b is smaller than γ in step S14 (NO in step S14), the power command values Pa* and Pb* are not changed, and program control advances to step S16.

Following this, in step S16, the controller 40 determines whether the actual power Pa_act of the DC power supply 10a is smaller than the power command value Pa*. The actual power Pa_act can be obtained by calculating Pa_act=Ia (or ILa) X Va. This processing is performed as the function of the power comparator 130 in FIG. 21. When the decision is affirmative in step S16, the processing advances to the next step S18, or when the decision is negative in step S16, the overpower avoidance control processing is terminated.

When it is ascertained at step S16 that the actual power Pa_act of the DC power supply 10a is smaller than the power command value Pa* (YES in step S16), in step S18, the controller 40 determines whether the actual power Pb_act of the DC power supply 10b is equal to or greater than the power threshold value β. This processing is performed also as the function of the power comparator 130 in FIG. 21. The actual power Pb_act can be obtained by calculating Pb_act=Ib (or ILb) X Vb. When the actual power Pb_act of the Dc power supply 10b is equal to or greater than the power threshold value β (YES in step S18), in step S20 the feedback control for the power increase side is allowed. In contrast, when the actual power Pb_act of the DC power supply 10b is smaller than the power threshold value β (NO in step S18), in step S22, the feedback control for the power increase side is inhibited. In this case, the feedback control for the power increase side for the DC power supply 10a is inhibited.

When the feedback control for the power increase side for the DC power supply 10a is inhibited, the power converter 50 performs DC/DC conversion (boosting operation) for the DC power supply 10b, and adjusts the actual power Pa_act of the DC power supply 10a to the present value or smaller, until the actual power Pb_act becomes equal to or greater than the power threshold value β. As a result, the control for increasing the power command value Pa* (=PH*−α) can be inhibited, so that the insufficient amount of the output power of the DC power supply 10b can be output from the DC power supply 10a during a period of the response lag of the power converter 50 with respect to the DC power supply 10b. Therefore, increasing of the power distribution ratio k of the DC power supply 10a beyond the upper limit kuplim can be avoided, and as a result, the occurrence of over-discharge of the DC power supply 10a can be effectively suppressed.

The explanation has been given for an example where the aB mode, in which only the output of the DC power supply 10a is boosted to compensate for the load power PL is shifted to the PB mode; however, in the opposite case; i.e., in a case wherein the bB mode in which only the output of the DC power supply 10b is boosted to compensate for the load power PL is shifted to the PB mode, the overpower avoidance control can also be performed in the same manner to maintain the power distribution ratio k in a predetermined range by setting the power command value Pa* of the DC power supply 10a equal to or greater than the lower limit value, so that the occurrence of overpower of the DC power supply 10b can be suppressed.

An explanation has been also given for a case wherein the power is output by the DC power supplies 10a and 10b; however, the case for which the overpower avoidance control is employed is not limited to the above case, and the processing can also be applied for avoidance of the overcharge of the DC power supplies 10a and 10b in a case wherein the regenerative power is input from the load 30 to the DC power supplies 10a and 10b.

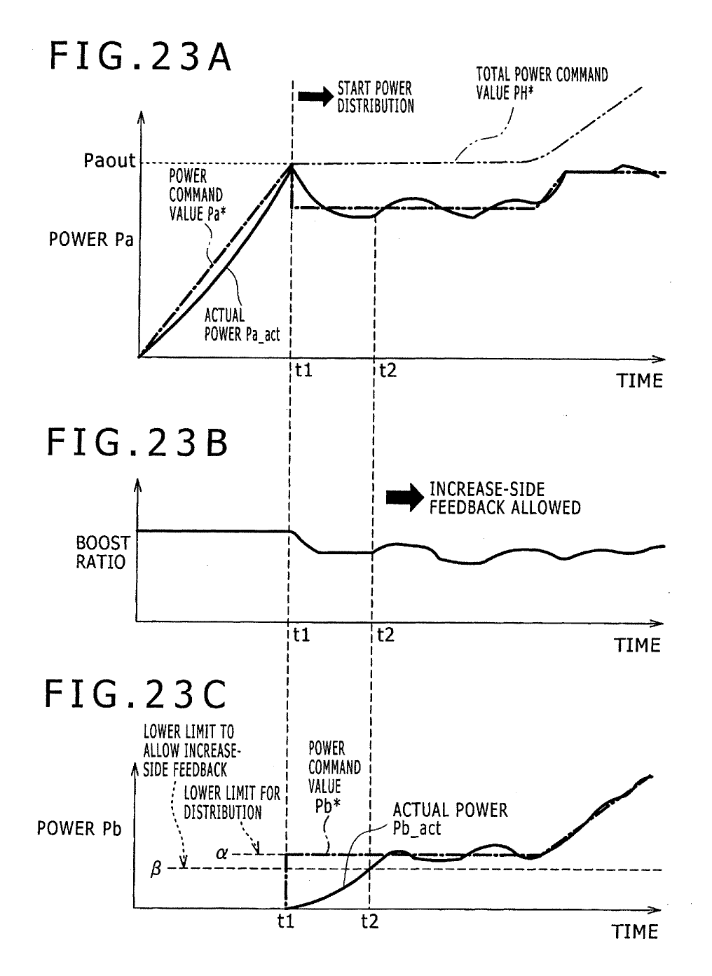

FIGS. 23A, 23B, and 23C are graphs depicting the overpower avoidance control described while referring to FIG. 22 is performed; FIG. 23A is a graph showing changes of the power command value Pa* and the actual power Pa_act for the DC power supply 10a, FIG. 23B is a graph showing the change of the boost ratio, and FIG. 23C is a graph showing the change of the power command value Pb* and the actual power Pb_act for the DC power supply 10b. These examples also show a case wherein the aB mode for supplying the load power PL by boosting only the output of the DC power supply 10a is shifted to the PB mode for supplying the load power PL by boosting the outputs of the two DC power supplies 10a and 10b.

Referring to FIG. 23A, the aB mode is employed by the power supply system 1 until time t1 is reached, and the actual power Pa_act is increased substantially in consonance with the increase of the power command value Pa*.

When, at time t1, the actual power Pa_act output by the DC power supply 10a has reached the discharge limit Paout that is set by the power management unit 100 (FIG. 18), the amount of power beyond this level cannot be output only by using the DC power supply 10a. Therefore, the controller 40 performs power distribution and permits the DC power supply 10b also to output the power, so that the total power PH can be output by using the two DC power supplies 10a and 10b.

At this time, as shown in FIGS. 23A and 23C, the power command value Pa* for the DC power supply 10a is set to PH*−α, and the power command value Pb* of the DC power supply 10b is set to the lower power limit α (step S13 in FIG. 22). In FIG. 23A, a dash-dot line indicates the state wherein, at time t1, the power command value Pa* of the DC power supply 10a is changed from Pa_out to PH*−α(=γ), and thereafter, is steadily maintained at least until time t2 is reached.

When the power is distributed to the two DC power supplies 10a and 10b in this manner, and supply of power is started also by the DC power supply 10b, the actual power Pa_act output by the DC power supply 10a is decreased, while the actual power Pb_act output by the DC power supply 10b is increased. However, because of the response lag of the boost operation performed by the power converter 50, a specific period of time (e.g., several hundreds of milliseconds) is required until the actual power Pb_act output by the Dc power supply 10b reaches the power command value Pb*. When the power feedback control for the DC power supply 10a is performed during the specific period, the sum of the actual power (Pa_act+Pb_act) supplied by the DC power supplies 10a and 10b is smaller than the total power command value PH*, and therefore, the control operation is performed to supply a shortage of power from the DC power supply 10a. Then, there is a possibility that the amount of power beyond the discharge limit Paout might be taken from the DC power supply 10a, and over-discharge may occur.

In this embodiment, therefore, the feedback control for the side where the output power of the DC power supply 10a is increased is inhibited until time t2 at which the actual power Pb_act of the DC power supply 10b reaches the power threshold value β (step S22 in FIG. 22). As a result, the occurrence of over-discharge of the DC power supply 10a can be suppressed, or prevented. After time t2, the feedback control for the power increase side for the DC power supply 10a is allowed (step S20 in FIG. 22), and the normal feedback control is performed.

As described above, according to the power supply system 1 of this embodiment, the output power Pb of the DC power supply 10b can be maintained in the range of α≦Pb≦γ. Further, in a case opposite to the above example, wherein the bB mode for boosting the output of only the DC power supply 10b to supply the power to the load 30 is shifted to the PB mode for supplying power by using the two DC power supplies 10a and 10b, the output power Pa of the DC power supply 10a can be maintained in a range of α≦Pa≦γ. Therefore, the power distribution ratio k is maintained in a range of klwlim≦k≦kuplim. Further, this control processing can be applied for a case wherein power is supplied to charge the DC power supplies 10a and 10b. Therefore, according to this embodiment, since power distribution for the DC power supplies 10a and 10s is appropriately performed, the occurrence of overpower (overcharge and over-discharge) of the DC power supplies 10a and 10b can be effectively suppressed.

The present invention is not limited to the arrangement in the above described embodiment and a modification thereof, and can be variously modified, or improved within the scope of the matters described in the claims of this invention and the equivalent scope.

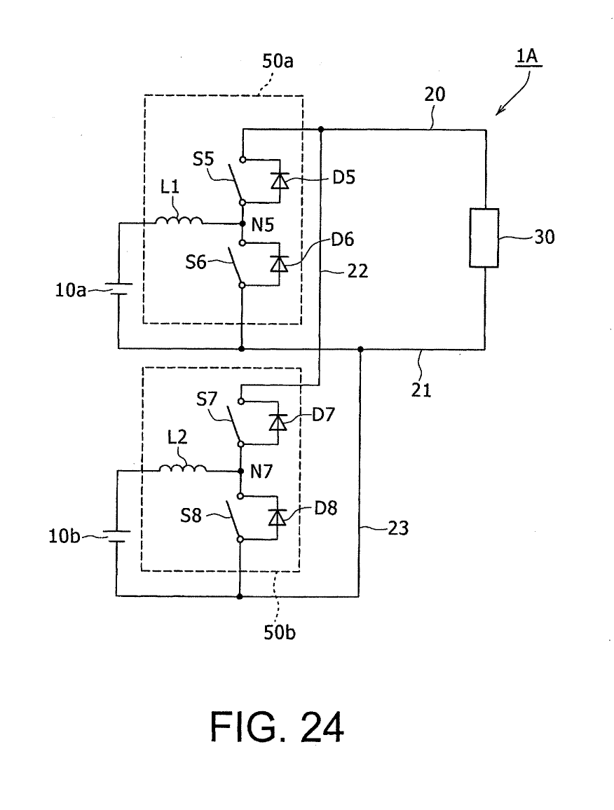

For example, for the power system 1 in this embodiment, an explanation has been given for the arrangement wherein the ON/OFF states of the switching elements S1 to S4 are controlled, so that the connection of the two DC power supplies 10a and 10b to the power line 20 can be changed to series condition or parallel connection. However, the present invention is not limited to this power supply system. The present invention may be applied for a power supply system 1A, as shown in FIG. 24, wherein power converters 50a and 50b independently controllable are provided for the individual DC power supplies 10a and 10b, and the DC power supplies 10a and 10b are connected in parallel to the power line 20 through the power converters 50a and 50b.

As shown in FIG. 24, the power converter 50a for the DC power supply 10a includes: a reactor L1 that is connected at one end to the positive terminal of the DC power supply 10a; a switching element S5 that serves as the upper arm element that is connected between the power line 20 and a node N5, which is connected to the other end of the reactor L1; and a switching element S6 that serves as a lower arm element connected between the node N5 and a ground line 21. Further, diodes D5 and D6 are connected in anti-parallel manner to the switching elements S5 and S6.

In contrast, the power converter 50b for the DC power supply 10b includes: a reactor L2 that is connected at one end to the positive terminal of the DC power supply 10b; a switching element S7 that serves as the upper arm element that is connected between the power line 20 and a node N7, which is connected to the other end of the reactor L2; and a switching element S8 that serves as a lower arm element connected between the node N7 and a ground line 23. Further, diodes D7 and D8 are connected in anti-parallel manner to the switching elements S7 and S8, and a power line 22 is connected to the power line 20 on the DC power supply 10a side, while the ground line 23 is connected to the ground line 21 on the DC power supply 10a side.

According to the power system 1A in FIG. 24, the connection of the DC power supplies 10a and 10b cannot be changed to series connection. Therefore, of the operating modes shown in FIG. 3 for this embodiment, the SB mode and the SD mode cannot be employed, but the other operating modes can be applied, and the power converter control and the overpower avoidance control can be performed in the same manner as in the embodiment.

In the power supply system 1A, the power converter 50b may be eliminated, and the DC power supply 10b may be connected directly to the power line 20 and the ground line 21. In this case, the PBD mode employed by the power supply system 1 can also be performed.

### REFERENCE SIGN LIST

1, 1A: power supply system
10a, 10b: DC power supply
11a, 11b: voltage sensor
12a, 12b: current sensor
20, 22: power line
21, 23: ground line
30: load
32: inverter
35: motor generator
36: drive force transmission gear
37: driving wheel
40: controller
50, 50a, 50b: power converter
80-89: current path
100: power management unit
110: overpower avoidance control unit
120: power command acquisition unit
130: power comparator
140: power command changing unit
150: feedback control switching unit
200: power control unit
210: deviation calculation unit
220: control operation unit
230: first limiter
240: power distribution unit
250: circulating power addition unit
260: second limiter
270: subtraction unit
300, 310: power control unit
302, 312: power command generator
304, 314: deviation calculation unit
306, 316: control operation unit
308, 318: FF addition unit
400: PWM control unit
410: carrier wave generator
CH: smoothing capacitor
D1-D8: diode
Ia, Ib, ILa, ILb: current
Ia*, Ib*: current command value
k: power distribution ratio
klwlim: lower limit of a power distribution ratio
kuplim: upper limit of a power distribution ratio
L1, L2: reactor
N1, N2, N3, N5, N7: node
Pa, Pb: output power
Pa*, Pb*: power command value
Pa_act, Pb_act: actual power
Pain, Pbin: charge limit
Paout, Pbout: discharge limit
Par: power
PH, PHr: total power
PH*: total power command value
PHmax: upper limit or maximum value of power
PHmin: lower limit of power
Pr: circulating power or circulating power value
Ra, Rb: internal resistance
S1-S8: switching element
SDa, SDb, SDc: control pulse signal
SG1-SG4: control signal
Ta, Tb: temperature
Va, Vb: voltage
VH: output voltage or system voltage
VH*: voltage command value
VHmax: upper limit voltage
VHrq: load demanding voltage
VR1-VR3: voltage range
ΔVH: voltage deviation
α, β: power threshold value

1. A power supply system comprising:
a load;
a power line connected to the load;
first and second DC power supplies being capable of supplying electric power to the load;
a power converter connected between the first and second DC power supplies and the power line; and
a controller for controlling an operation of the power converter,
wherein the first and second DC power supplies are capable of being connected in parallel to the power line,
wherein an operating mode is capable of being switched between a first operating mode, in which only one of the first and second DC power supplies inputs or outputs electric power demanded by the load, and a second operating mode, in which the electric power demanded by the load is distributed into power to be input/output respectively by the first and second DC power supplies, and the first and second DC power supplies input and output the power thus distributed, and
wherein when shifting of the first operating mode to the second operating mode is started, the controller sets input and output power command values for the other of the first and second DC power supplies to be equal to or higher than a lower limit value, and maintains, within a predetermined range, a ratio of the input and output power command values for the first and second DC power supplies, relative to the power demanded by the load.

2. The power supply system according to claim 1, wherein the controller is capable of performing feedback control to bring actual power values of the first and second DC power supplies close to the input and output power command values, and when the actual power of the other of the first and second DC power supplies is lower than a predetermined power threshold value in the second operating mode, the controller inhibits the feedback control for increasing the actual power of the one of the first and second DC power supplies.

3. The power supply system according to claim 2, wherein, when the actual power of the other of the first and second DC power supplies is lower than the predetermined power threshold value, the controller inhibits the feedback control for increasing the actual power of the one of the first and second DC power supplies, and when the actual power of the other of the first and second DC power supplies is equal to or higher than the predetermined power threshold value, the controller allows the feedback control for increasing the actual power of the one of the first and second DC power supplies.
